(19) United States
(12) Patent Application Publication
(10) Pub. No.: US 2026/0163632 A1
(43) Pub. Date: Jun. 11, 2026

(54) WIRELESS COMMUNICATION IN A SIDELINK AND BEAM MANAGEMENT

(71) Applicant: HUAWEI TECHNOLOGIES CO., LTD., Shenzhen (CN)

(72) Inventors: Mario Hernán CASTAÑEDA GARCIA, Munich (DE); Xitao GONG, Munich (DE); Richard Stirling-Gallacher, Munich (DE)

(21) Appl. No.: 19/465,467

(22) Filed: Jan. 30, 2026

Related U.S. Application Data
(63) Continuation of application No. PCT/EP2023/071298, filed on Aug. 1, 2023.

(51) Int. Cl. H04B 7/06; H04W 72/25

(52) U.S. Cl. CPC H04B 7/06952; H04W 72/25

(57) ABSTRACT

The present disclosure relates to an entity for wireless communication in a sidelink, the entity being configured to use, for beam management, a set of resources from multiple resources, wherein the multiple resources are configured for beam management. Further, an entity for wireless communication in a sidelink is disclosed, the entity being configured to search for control information in multiple resources that are configured for beam management. Furthermore, an entity for wireless communication is disclosed, the entity being configured to configure, for beam management by one or more further entities for wireless communication in a sidelink, multiple resources. Moreover, corresponding methods for wireless communication are disclosed.

### CROSS-REFERENCE TO RELATED APPLICATIONS

This application is a continuation of International Application No. PCT/EP2023/071298, filed on Aug. 1, 2023, the disclosure of which is hereby incorporated by reference in its entirety.

### TECHNICAL FIELD

The present disclosure relates to entities and methods for wireless communication in a sidelink, in particular with regard to beam management.

### BACKGROUND

Sidelink communication in new radio (NR) vehicle to everything (V2X) in 3GPP Rel. 16 and Rel. 17 has been mainly designed for lower frequencies, i.e. for frequency range 1 (FR1). Sidelink communication at higher frequencies, e.g. frequency range 2 (FR2), may be considered by employing the same design for FR1, but with basically no specific optimization for supporting higher frequencies in Rel. 16 and Rel. 17. Hence, beam management procedures, e.g. beam sweeping, beam alignment, beam maintenance, are not supported in the current NR V2X standard, i.e. in Rel. 16 and Rel. 17.

### SUMMARY

Higher frequencies are attractive due to the available bandwidth at such frequencies, which can support high data rate transmissions in the sidelink. High data rates are required by several V2X use cases like advanced driving and extended sensors as well as commercial applications. However, the transmissions at higher frequencies require beamforming to compensate for the pathloss at higher frequencies. In addition, beamforming enables directional transmissions, which can be leveraged for a spatial reuse of available resources to support high connection density of devices.

Recently, a study within a 3GPP Rel. 18 work item considering enhanced sidelink operation at higher frequencies, i.e. FR2, has been kicked off in 3GPP Rel. 18. The focus of this study is on sidelink beam management for unicast communication, i.e. between pair of user equipments (UEs), in FR2 licensed bands. As FR2 specific design is not supported in previous releases, backward compatibility is not required.

In NR V2X in 3GPP Rel. 16 and Rel. 17, a sub-set of available resources may be (pre-)

configured to be employed for sidelink data transmissions by multiple UEs. A sub-set of available resources for sidelink transmissions may be referred to as a resource pool (RP) for sidelink transmissions. (Pre-)configuration may refer to: a configuration that is defined by the network and is signalled to the UE by a network device (when the UE is in network coverage); or a configuration that is predefined in the UE, e.g. when the UE is out of network coverage. A network device can be a next generation node B (gNB), a base station (BS), road side unit (RSU), a transmit/receive point (TRP) or the like. A UE can be a mobile phone, a handheld device, a device on a vehicle or a device on a robot, or the like. In the following gNB or base station is used to refer to a network device in general.

In the time domain, an RP comprises contiguous or non-contiguous slots, where each slot comprises multiple symbols. In the frequency domain, an RP is divided into a given number of contiguous sub-channels.

In NR V2X, the data payload, i.e. a data packet, is carried in the Physical Sidelink Shared Channel (PSSCH), which can occupy one or more sub-channels. The data payload or data packet may also be referred to as transport block (TB). The sidelink control information (SCI) associated with a data transmission is transmitted in two stages: a 1^{st}-stage SCI and a 2^{nd}-stage SCI. The term “send” and “transmit” may be used as synonyms. The 1^{st}-stage is carried in the Physical Sidelink Control Channel (PSCCH) in non-overlapping resources within the sub-channel(s) occupied by the associated PSSCH. The 2^{nd}-stage SCI is multiplexed with the PSSCH.

The 1^{st}-stage SCI indicates the resources of a current data transmission and it may indicate the resources for retransmissions of the same data packet. In addition, the 1^{st}-stage SCI may indicate a resource reservation period, which is the time period between reserved resources for the transmission of consecutive data packets, i.e. the sub-channel(s) of a current data transmissions are reserved on the slot after the resource reservation period for the transmission of another data packet.

By decoding the 1^{st}-stage SCI, a receiver user equipment (Rx UE) may be aware of the sub-channel(s) occupied by a current data transmission carried in a PSSCH, as well as the sub-channel(s), which are reserved for future (re)transmissions of the same or new data packets.

The 2^{nd}-stage SCI indicates the source identifier (ID) and the destination ID of a data transmission. By decoding the 2^{nd}-stage SCI, a Rx UE may be aware if it is a target Rx UE of a TB carried in a PSSCH. Another part of the source ID and destination ID is carried in a medium access control (MAC) subheader, i.e. MAC control element (CE), which is carried by the PSSCH associated with a 2^{nd}-stage SCI. Thus, the source ID and destination ID may be split into two parts: one part is carried in the 2^{nd}-stage SCI and another part in the MAC subheader. Hence, a Rx UE may need to decode a PSCCH and the PSSCH to be aware of the complete source ID and destination ID of a data transmission.

The sub-channels for a data transmission may be selected based on resource allocation mode 1 and mode 2. In mode 1, the sub-channel(s) for a data transmission are assigned by the network, i.e. a gNB indicates to a UE the resources that it shall use for a data transmission. In mode 2, a UE can autonomously select sub-channel(s) for a data transmission.

For a transmission in mode 2, a UE identifies candidate resources in a selection window by sensing for occupied resources within a sensing window along with the identification of future reserved resources. A UE identifies an occupied resource by detecting a PSCCH along with the reserved resources indicated by the 1^{st}-stage SCI carried by a PSCCH. The sensing UE may detect the presence of a PSCCH based on the demodulation reference signals (DMRS) sent within the PSCCH, i.e. if the reference signal received power (RSRP) of the PSCCH DMRS is above a threshold. For this purpose, a UE searches for a PSCCH at all potential PSCCH locations in each sub-channel of the slots in the sensing window and decodes the 1st-stage SCI if it finds a PSCCH.

To support sidelink transmissions at higher frequencies, beam management procedures in the sidelink are required. An important part of the beam management is beam sweeping (may be also referred to as “beam training”), which comprises training multiple beams at a transmitter user equipment (Tx UE) and a receiver user equipment (Rx UE). Beams sweeping may be employed for an initial beam alignment (may be referred to as “beam pairing”), i.e. between a Tx UE and a Rx UE. The beam alignment comprises determining the best beams between a pair of UEs, i.e. to identify the best transmission beam (Tx beam) at the Tx UE and the best receive beam (Rx beam) at the Rx UE.

In beam sweeping, multiple reference signals (RS) may be transmitted with multiple Tx beams. In contrast to Uu link, i.e. to the access link between gNB and a UE, beam sweeping using synchronization signals may not be possible in sidelink. This is due to the fact that the Tx UE may not be transmitting sidelink synchronization signals, as only UEs acting as a synchronization reference (SyncRef UE) are currently configured to do so in NR V2X in Rel. 16 and Rel. 17. The sidelink synchronization signal is transmitted in a sidelink synchronization signal block (S-SSB).

A UE could be configured to transmit synchronization signals with different Tx beams for the beam pairing. However, configuring a Tx UE to transmit synchronization signals, i.e. S-SSBs, for beam alignment purposes goes against the current procedure of triggering of S-SSB transmissions in NR V2X, where having many UEs sending synchronization information is not desired. Currently, only Tx UEs fulfilling certain conditions are allowed to transmit S-SSBs in NR V2X in Rel. 16 and Rel. 17.

In addition, there is no random access channel (RACH) in sidelink, i.e. a UE receiving a synchronization signal from a SyncRef UE does not need to send a reply back to the SyncRef UE. This means that a UE sending synchronization signals is not aware of a UE receiving S-SSBs. This is in contrast to the Uu link, where a UE receiving a synchronization signal transmits back a response in the RACH which supports the beam pairing between the gNB and the UE. Such a response may be referred to as an alignment response.

Furthermore, the S-SSBs in NR V2X are identified with a sidelink synchronization signal (SLSS) identifier (ID) which is not unique to a UE. This means that the identity of a UE sending S-SSBs may not be distinguishable with the SLSS ID.

Moreover, S-SSBs are sent on resources which are not dedicated to one UE in NR V2X, i.e. multiple SyncRef UEs can transmit on such a resource with resource selection based on a rule depending on the S-SSB triggering procedure. Thus, a Rx UE may not be aware that a measurement with a Rx beam corresponds to one or more signals sent by one or more Tx UEs on the same resource.

An aspect to consider when performing beam alignment is a link establishment between a pair of UEs. In this regard, there are three possibilities based on the link establishment between a pair of UEs. As a Tx UE or an Rx UE may not be aware of the presence of each other in advance, a link establishment procedure is performed between the pair of UEs, i.e. by the Tx UE transmitting direct communication (DCR) messages and by the Rx UE replying back with direct communication accept (DCA) message. The DCR and DCA message are transmitted on a PSSCH. The initial beam alignment between a Tx UE and a Rx UE may be performed before, during or after the link establishment procedure.

Performing the initial beam alignment before the link establishment may lead to having identified initial beam pairs between UEs that are not interested in establishing a link. Performing the initial beam alignment during the link establishment would require modifications to the current procedure in NR V2X, which does not support the transmission with Tx and Rx beams. Performing the initial beam alignment after the link establishment may limit the coverage of the sidelink transmission between a pair of UEs, as the link establishment may need to be performed with an omnidirectional beam instead of employing beamformed transmissions, which could support transmission at higher frequencies over a larger distance.

Part of the beam management procedures comprise beam maintenance, which allows for tracking of other possible beam pairs, i.e. for selecting a new Tx beam and/or Rx beam due to a beam failure. For beam maintenance, beam sweeping may also be considered. Beam sweeping and related procedures for beam maintenance may be similar to the initial beam alignment after the link establishment discussed above.

Besides beam alignment, several other factors are to be considered for sidelink transmissions at higher frequencies. Depending on UE capability or configuration, a UE may be able to transmit or receive with one Tx or Rx beam at a time, respectively. This means that a Rx UE may not be able to receive a sidelink transmission (including the associated SCI) with a given Tx beam at the Tx UE or with a given Rx beam at the Rx UE. This is exemplarily shown in FIG. 11a. In FIG. 11a, a Tx UE 111 transmits using the Tx beam 111a, and the Rx UE 112 is configured to receive using the Rx beam 112a. As may be seen in FIG. 11a, there is no beam alignment between the Tx beam 111a at the Tx UE 111 and the Rx beam 112a at the Rx UE 112. Therefore, in the scenario exemplarily shown in FIG. 11a, the Rx UE 112 cannot receive a sidelink transmission from the Tx UE 111.

Furthermore, an Rx UE may only know it is a target Rx UE of a transmission, after determining the destination ID as well as possibly the source ID carried in the SCI of a transmission. An Rx UE may also need to decode an associated PSSCH carrying a MAC CE to determine the other part of destination ID and source ID. However, to receive an SCI and the associated PSSCH, the Tx and Rx beams need to be aligned. That is, there needs to be beam alignment. With the measurements during the beam sweeping, the Rx UE may be aware of the best Tx and Rx beam.

In view of the above, this disclosure aims to provide entities for wireless communication that allow a communication at higher frequencies, e.g. frequency range 2 (FR2). An objective of this disclosure is to provide entities for wireless communication that allow a sidelink communication at higher frequencies, e.g. frequency range 2 (FR2).

These and other objectives are achieved by the solution of this disclosure as described in the independent claims. Advantageous implementations are further defined in the dependent claims.

A first aspect of this disclosure provides an entity for wireless communication in a sidelink, wherein the entity is configured to use, for beam management, a set of resources from multiple resources, wherein the multiple resources are configured for beam management.

That is, the entity is configured to perform beam management using the set of resources

from the multiple resources that are configured for beam management. The passage “multiple resources are preconfigured for beam management” and the passage “multiple resources are configured for beam management” may be used as synonyms. In other words, for supporting beam management, such as a beam alignment in a sidelink, at higher frequencies, it is proposed to (pre-)configure multiple resources to be used for the beam management. Thus, the entity according to the first aspect allows communication, such as a sidelink communication, at higher frequencies, e.g. frequency range 2 (FR2). The (pre-)configuration of the multiple resources for the beam management may be a configuration that is defined by a network, of which the entity may be configured to be part of, and may be signalled to the entity by a network device of the network (when the entity is in network coverage). Alternatively or additionally, the (pre-)configuration of the multiple resources for the beam management may be a configuration that is (pre-)defined in the entity, e.g. when the entity is out of network coverage. The network may be a communication network, e.g. a cellular network. Using the set of resource from the multiple resources has the advantage that the set of resources may be used by the entity for beam sweeping or other beam management procedures for a sidelink. With the set of resources the entity may know on which resources to transmit or receive reference signals for beam sweeping as well as on which resources to transmit or receive an alignment response.

The entity is configured to wirelessly communicate in a sidelink, i.e. perform a wireless sidelink communication. The term “sidelink” may be used to refer to a sidelink communication. The entity may be configured to use, for beam management for a sidelink, the set of resources from the multiple resources. The multiple resources may be configured for beam management for a sidelink. In the present disclosure, beam management may mean beam management for a sidelink. Thus, in the present disclosure, a process or processes (such as beam sweeping, beam alignment etc.) of the beam management may be a beam management process or beam management processes for a sidelink (such as beam sweeping for a sidelink, beam alignment for a sidelink etc.). Beam management for a sidelink may be referred to as “sidelink beam management”. A sidelink communication may be understood as a wireless communication in a sidelink, i.e. using a sidelink.

The set of resources supports entity-specific flexible beam sweeping, which has the advantage that the entity may sweep different number of transmission beams (Tx beams) or receive beams (Rx beams). That is, the entity may sweep different number of Tx beams or Rx beams depending on its capability. Furthermore, the set of resources also enables a flexible alignment response. For example, the entity may be configured to indicate, as a transmitter (e.g. Tx UE), on which one or more resources of the set of resource an alignment response associated with a given transmission beam (Tx beam) transmission may be transmitted from another entity for wireless communication being a receiver (e.g. Rx UE) to the entity (and, thus, may be received by the entity). This may be instead of having a fixed mapping between resources for beam sweeping and for the alignment response for all beam pairs of the entity and the other entity.

Since the multiple resources are configured for beam management, they may be used by the entity and other entities for wireless communication of a network, of which the entity may be part of, for beam management. This has the advantage that beam management procedures, such as beam sweeping, performed on the multiple resources, e.g. on the set of resources, are more reliable and are not impacted by data transmissions, e.g. data transmission in the network. In other words, there is no interference between data transmissions and beam management procedures.

A resource, e.g. each resource, of the multiple resources (that are configured for beam management) may comprise in time domain one or more symbols in one or more sub-channels in the frequency domain. This allows tailoring granularity of resources for supporting multiple beam sweeping in a slot. A resource, e.g. each resource, of the set of resources may comprise in time domain one or more symbols in one or more sub-channels in the frequency. Two or more resources of the set of resources may be different. The multiple resources, which are configured for beam management, may be part of a resource pool, such as a resource pool for sidelink communication. In the time domain, the resource pool may comprise contiguous or non-contiguous slots, where each slot comprises multiple symbols. In the frequency domain, the resource pool may be divided into multiple contiguous sub-channels.

Sidelink communication may be understood as a direct communication of a signal (e.g. one or more packets) between two or more entities without using a network device for communicating the signal. That is, the communication does not traverse or go via the network device. The two or more aforementioned entities performing sidelink communication may be said to wirelessly communicate with each other in a sidelink. Thus, they are entities for a wireless communication in a sidelink. For example, sidelink communication between two or more user equipments (UEs), such as two mobile UEs in a cellular network, may be understood as a direct communication of a signal (e.g. one or more packets) between the two or more UEs without using a network device, such as a base station (BS), for communicating of the signal. That is the communication does not traverse or go via the network device, such as the BS. The term “device-to-device communication (D2D communication)” may be used as a synonym for sidelink communication.

The entity may be implemented by software and/or hardware. The entity may be a device for wireless communication, e.g. configured to communicate using RF waves. The entity may be a user equipment (UE). An UE may be a mobile phone, a handheld device, a device on a vehicle or a device on a robot, or the like. The entity may be a transmitter UE (Tx UE). Wireless communication may comprise or may be communication using radio frequency (RF) waves. The entity may be an entity, such as a device, configured for sidelink communication.

Beam management may comprise procedures for establishing and/or retaining an optimal beam pair between two entities for wireless communication for achieving a good connectivity between the two entities. A beam pair may comprise a transmission beam (Tx beam) and a corresponding receive beam (Rx beam) in one link direction. The procedures may comprise layer 1 (PHY) and/or layer 2 (MAC) procedures. For example, beam management may comprise beam sweeping, beam alignment, beamforming, beam maintenance, beam failure recovery etc. The term “beam pairing” may be used as a synonym for the term “beam alignment”. The term “beam training” may be used as a synonym for the term “beam sweeping”. The entity may be configured to use multiple resources of the set of resources for beam sweeping of multiple beams of the entity, e.g. transmission beams of the entity and/or receive beams of the entity. The entity may be configured to use one or more resources, optional the rest, of the set of resources for receiving an alignment response, e.g. in case a beam alignment is achieved between a beam (e.g. transmission beam) of the entity and a beam (e.g. receive beam) of another entity for wireless communication is achieved. The terms “alignment response” and “beam alignment response” may be used as synonyms.

Beam alignment may be understood as the process of determining the best beam pair for wireless communication between a first entity for wireless communication and second entity for wireless communication that comprises a transmission beam of the first entity and a corresponding receive beam of the second entity. In other words, beam alignment may be understood as identifying the best transmission beam at a first entity for wireless communication and the best receive beam at a second entity for wireless communication, assuming that the first entity intends to wirelessly transmits data to the second entity and, thus, the first entity is a transmitter entity and the second entity is a receiver entity.

A beam of an entity for wireless communication may be a spatial filter of the entity for wireless communication. The passages “transmit with a beam” and “transmit using a beam” may be understood as synonyms.

The entity may be configured to be part of a network (e.g. communication network, such as cellular network) comprising multiple entities, wherein the multiple resources are usable by all entities of the network for performing beam management. In other words, the multiple resources are shared by all entities of the network. This provides a more efficient use of resources. The multiple entities may be multiple user equipments (UEs). The sharing of the multiple resources, which are configure for beam management, by the entities of the network may be according to sharing of sub-channels in a resource pool by the entities for their data transmission. The multiple resources that are configured for beam management have the advantage that these resources may be used for beam sweeping by multiple entities of the network. With the multiple resources that are configured for beam management, the entities of the network know on which resources to transmit or receive reference signals for beam sweeping as well as on which resources to transmit or receive an alignment response. The reference signals may comprise or be at least one of a demodulation reference signal (DMRS), channel state information reference signal (CSI-RS), sidelink CSI-RS, sounding reference signal (SRS), synchronization signal block (SSB), sidelink SSB, primary synchronization signal (PSS), secondary synchronization signal (SSS), sidelink PSS, sidelink SSS, positioning reference signal (PRS), sidelink PRS, or the like.

In an implementation form of the first aspect, the entity is configured to perform beam management for a sidelink by transmitting and receiving one or more signals with one or more beams on the set of resources.

That is, the entity may be configured to perform beam management for a sidelink communication (i.e. sidelink beam management), wherein performing the sidelink beam management comprises transmitting and receiving one or more signal with one or more beams on the set of resources. In other words, the entity may be configured to use the set of resources from the multiple resource, which are configured for beam management, to transmit and receive one or more signals, which are used during sidelink beam management, with one or more beams. The entity may be configured to achieve beam alignment (e.g. beam alignment for a sidelink) with another entity for wireless communication by transmitting to and receiving from the other entity with one or more beams on the set of resources of the multiple resources. In other words, the entity may be configured to achieve beam alignment with the other entity using the set of resources from the multiple resources that are configured for beam management.

In an implementation form of the first aspect, the entity is configured to use, for beam management, the set of resources from the multiple resources, wherein the multiple resources are configured for beam management and are part of a resource pool for sidelink communication.

In the time domain, the resource pool may comprise contiguous or non-contiguous slots, where each slot comprises multiple symbols. In the frequency domain, the resource pool may be divided into multiple contiguous sub-channels. The resource pool may comprise a group of resources that are configured for data transmission, e.g. transmitting a data payload, i.e. a data packet. That is, the resource pool may comprise the multiple resources that are configured for beam management and the group of resources that are configured for data transmission.

In an implementation form of the first aspect, the entity is configured to communicate according to a communication protocol, and the multiple resources are configured, according to the communication protocol, for beam management.

The communication protocol may comprise rules for sidelink communication. The communication protocol may be outlined in a communication standard, such as LTE, 5G or a new standard to be decided on. For example, according to the communication protocol, the entity may be configured to wirelessly receive the configuration of the multiple resources (i.e. information on the multiple resource configured for beam management) from a further entity. The further entity may be a network device. A network device may be a next generation node B (gNB), a base station (BS), road side unit (RSU), a transmit/receive point (TRP) or the like. For example, according to the communication protocol, the configuration of the multiple resources can be stored in an internal data storage of the entity or an external data storage accessible by the entity.

In an implementation form of the first aspect, the entity is configured to obtain information on the set of resources from another entity for wireless communication, or select the set of resources from the multiple resources.

The selection of resource may be done based on a resource allocation mode 1 or a resource allocation mode 2. In the mode 1, the entity may obtain the information on the set of resource from the other entity. In the mode 2, the entity may select itself the set of resources from the multiple resources. The other entity may be a network device. That is, the set of resources may be selected by a network, of which the entity may be part. A network device may be a next generation node B (gNB), a base station (BS), road side unit (RSU), a transmit/receive point (TRP) or the like. The entity may obtain the information on the set of resource from a user equipment (UE). That is, the other entity may be a UE.

In an implementation form of the first aspect, the entity is configured to select the set of resources from the multiple resources by
searching, in the multiple resources, for control information using a beam of the entity,
determining based on the control information of one or more resources of the multiple resource, for which the control information is found using the beam, one or more reserved resources of the multiple resources,
determining among the multiple resources free resources by excluding the determined one or more reserved resources from the multiple resources, and
selecting at least one of the determined free resources as one or more resources of the set of resources.

The control information may be in the Physical Sidelink Control Channel (PSCCH) of the multiple resources. Thus, the entity may be configured to search in the multiple resources for PSCCH using a beam of the entity.

In an implementation form of the first aspect, the entity is configured to select, for the beam, one or more of the determined free resources as one or more resources for transmitting a reference signal with the beam.

The entity may be configured to select, for the beam, one or more of the determined free resources as one or more resources for performing beam sweeping using the beam,

In an implementation form of the first aspect, the entity is configured to select, from the set of resources, a sub-set of one or more resources for transmitting with a beam of the entity a reference signal on the sub-set of one or more resources.

The aforementioned sub-set of one or more resources for transmitting with a beam of the entity a reference signal on the sub-set of one or more resources may be referred to as “first sub-set”. In this context, the term “first” is merely used to distinguish the aforementioned sub-set from other sub-sets described herein.

In an implementation form of the first aspect, the entity is configured to transmit with the beam the reference signal and control information associated with the beam on the sub-set (first sub-set) of one or more resources.

That is, the entity is configured to perform beam sweeping by transmitting with the beam the reference signal and the control information associated with the beam on the sub-set (first sub-set) of one or more resources. In other words, the entity may be configured to map the sub-set (first sub-set) of one or more resources to a transmission, using the beam of the entity, of the reference signal and control information associated with the beam. Transmitting of the reference signal allows for training a transmission beam-receive beam pair (Tx beam-Rx beam pair), i.e. aligning a transmission beam (Tx beam) and a receive beam (Rx beam).

In this disclosure, a reference signal (i.e. the reference signal mentioned above or any other reference signal mentioned herein) may comprise or be at least one of a demodulation reference signal (DMRS), channel state information reference signal (CSI-RS), sidelink CSI-RS, sounding reference signal (SRS), synchronization signal block (SSB), sidelink SSB, primary synchronization signal (PSS), secondary synchronization signal (SSS), sidelink PSS, sidelink SSS, positioning reference signal (PRS), sidelink PRS, or the like.

The control information associated with the beam may comprise information on the sub-set (first sub-set) of one or more resources. The control information may comprise a destination identifier (ID) and optionally a source ID. The control information may comprise control information in the Physical Sidelink Control Channel (PSCCH) and control information in the Physical Sidelink Shared Channel (PSSCH). That is the control information may comprise control information carried by the PSCCH, and control information carried by the PSSCH. Optionally, the control information may comprise a medium access control (MAC) sub-header carried in the Physical Sidelink Shared Channel (PSSCH). The control information may be sent only in the PSCCH, such that the reference signal may be sent with a PSCCH in a standalone manner, i.e., without any PSSCH.

The control information in the Physical Sidelink Control Channel (PSCCH) may be referred to as 1^{st}-stage sidelink control information (SCI), and the control information in the Physical Sidelink Shared Channel (PSSCH) may be referred to as 2^{nd}-stage SCI. The 1^{st}-stage SCI may comprise information on the sub-set (first sub-set) of one or more resources. This allows other entities for wireless communication that perform sensing and receive the control information to know which resources are reserved (e.g. after decoding the PSCCH). Optionally, the 1^{st}-stage SCI may comprise the destination identifier (ID) and optionally the source ID. The 2^{nd}-stage SCI may comprise the source ID in case it is not comprised by the 1^{st}-stage SCI.

In an implementation form of the first aspect, the entity is configured to select, from the set of resources, a sub-set of one or more resources for receiving a beam alignment response with regard to a beam of the entity.

The aforementioned sub-set of one or more resources for receiving a beam alignment response with regard to a beam of the entity may be referred to as “second sub-set”. In this context, the term “second” is merely used to distinguish the aforementioned sub-set from other sub-sets described herein.

The control information associated with the beam may comprise information on the sub-set (second sub-set) of one or more resource for receiving the beam alignment response with regard to the beam. The 1^{st}-stage SCI or the 2^{nd}-stage SCI may comprise the information on the sub-set (second sub-set) of one or more resource for receiving the beam alignment response with regard to the beam. This allows an entity for wireless communication that receives the control information and intends to transmit an alignment response to know on which resource(s) to transmit the alignment response.

In an implementation form of the first aspect, the entity is configured to receive the beam alignment response with regard to the beam of the entity on the sub-set (second sub-set) of one or more resources for receiving the beam alignment response with regard to the beam of the entity.

The entity may be configured to listen for the beam alignment response with regard to the beam of the entity on the sub-set (second sub-set) of one or more resources for receiving the beam alignment response with regard to the beam of the entity.

In an implementation form of the first aspect, the entity is configured to select, from the set of resources, a sub-set of resources for transmitting with multiple beams of the entity a reference signal on the sub-set of resources.

The aforementioned sub-set of resources for transmitting with multiple beams of the entity a reference signal on the sub-set of resources may be referred to as “third sub-set”. In this context, the term “third” is merely used to distinguish the aforementioned sub-set from other sub-sets described herein.

In an implementation form of the first aspect, the entity is configured to transmit with a beam of the multiple beams of the entity the reference signal and control information associated with the beam on one or more resources of the sub-set (third sub-set) of resources.

That is, the entity is configured to perform beam sweeping by transmitting with the beam of the multiple beams the reference signal and the control information associated with the beam on the one or more resources of the sub-set (third sub-set) of resources.

The control information associated with the beam may comprise information on the sub-set (third sub-set) of resources and/or the one or more resources of the sub-set (third sub-set) of resources. The control information may comprise a destination identifier (ID) and optionally a source ID. The control information may comprise control information in the Physical Sidelink Control Channel (PSCCH) and control information in the Physical Sidelink Shared Channel (PSSCH). That is, the control information may comprise control information carried by the PSCCH, and control information carried by the PSSCH. Optionally, the control information may comprise a medium access control (MAC) sub-header carried in the Physical Sidelink Shared Channel (PSSCH). The control information may be sent only in the PSCCH, such that the reference signal may be sent with a PSCCH in a standalone manner, i.e., without any PSSCH.

The control information in the Physical Sidelink Control Channel (PSCCH) may be referred to as 1^{st}-stage sidelink control information (SCI), and the control information in the Physical Sidelink Shared Channel (PSSCH) may be referred to as 2^{nd}-stage SCI. The 1^{st}-stage SCI may comprise information on the sub-set (third sub-set) of resources and/or the one or more resources of the sub-set (third sub-set) of resources. This allows other entities for wireless communication that perform sensing and receive the control information to know which resources are reserved (e.g. after decoding the PSCCH). Optionally, the 1^{st}-stage SCI may comprise the destination identifier (ID) and optionally the source ID. The 2^{nd}-stage SCI may comprise the source ID in case it is not comprised by the 1^{st}-stage SCI.

Transmitting of the reference signal allows for training a transmission beam-receive beam pair (Tx beam-Rx beam pair), i.e. aligning a transmission beam and a receive beam.

In an implementation form of the first aspect, the entity is configured to select, for the beam, the one or more resources from the sub-set (third sub-set) of resources.

In other words, the entity may be configured to map the one or more resources of the sub-set (third sub-set) of resources to a transmission, using the beam of the multiple beams of the entity, of the reference signal and control information associated with the beam.

In an implementation form of the first aspect, the entity is configured to select, from the set of resources, a sub-set of resources for receiving a beam alignment response with regard to multiple beams of the entity.

The aforementioned sub-set of resources for receiving a beam alignment response with regard to multiple beams of the entity may be referred to as “fourth sub-set”. In this context, the term “fourth” is merely used to distinguish the aforementioned sub-set from other sub-sets described herein.

The control information associated with the beam may comprise information on the sub-set (fourth sub-set) of resources for receiving a beam alignment response with regard to the multiple beams. The 1^{st}-stage SCI or the 2^{nd}-stage SCI may comprise the information on the sub-set (fourth sub-set) of resources for receiving a beam alignment response with regard to the multiple beams. This allows an entity for wireless communication that receives the control information and intends to transmit an alignment response to know on which resource(s) to transmit the alignment response.

In an implementation form of the first aspect, the entity is configured to select, for a beam of the multiple beams, one or more resources for receiving the beam alignment response with regard to the beam of the multiple beams from the sub-set (fourth sub-set) of resources for receiving the beam alignment response with regard to the multiple beams of the entity.

The control information associated with the beam may comprise information on the one or more resources for receiving the beam alignment response with regard to the beam of the multiple beams of the sub-set (fourth sub-set) of resources. The 1^{st}-stage SCI or the 2^{nd}-stage SCI may comprise the information on the one or more resources for receiving the beam alignment response with regard to the beam of the multiple beams of the sub-set (fourth sub-set) of resources.

In an implementation form of the first aspect, the entity is configured to receive the beam alignment response with regard to the beam of the multiple beams on the selected one or more resources.

The entity may be configured to listen for the beam alignment response with regard to the beam of the multiple beams on the selected one or more resources. The entity may be configured to listen for the beam alignment response with regard to the multiple beams on the sub-set (fourth sub-set) of resources for receiving the beam alignment response with regard to the multiple beams.

In an implementation form of the first aspect, the entity is configured to search for control information in the multiple resources.

In an implementation form of the first aspect, the entity is configured to obtain information on the multiple resources from a further entity for wireless communication, and/or a data storage associated to the entity.

In other words, the entity may be configured to obtain the configuration of the multiple resources from the further entity and/or the data storage associated to the entity. The entity may be configured to wirelessly receive the multiple resources from the further entity. The further entity may be a UE. The further entity may be a network device. A network device may be a next generation node B (gNB), a base station (BS), road side unit (RSU), a transmit/receive point (TRP) or the like. The data storage may be an internal data storage of the entity or an external data storage accessible by the entity.

In order to achieve the entity according to the first aspect of this disclosure, some or all of the implementation forms and optional features of the first aspect, as described above, may be combined with each other.

A second aspect of this disclosure provides an entity for wireless communication in a sidelink, wherein the entity is configured to search for control information in multiple resources that are configured for beam management.

The entity is configured to wirelessly communicate in a sidelink, i.e. perform a wireless sidelink communication. The multiple resources may be configured for beam management for a sidelink (i.e. for sidelink beam management). The entity may be configured to search for control information in the multiple resources, wherein the multiple resources may be configured for beam management among resources of a resource pool for sidelink communication. In the time domain, the resource pool may comprise contiguous or non-contiguous slots, where each slot comprises multiple symbols. In the frequency domain, the resource pool may be divided into multiple contiguous sub-channels. The resource pool may comprise a group of resources that are configured for data transmission, e.g. transmitting a data payload, i.e. a data packet.

The entity may be configured to search for control information at one or more expected positions in each resource of the multiple resources. The entity may be configured to search for control information in the multiple resources that are configured for beam management using one or more beams. The entity may be implemented by software and/or hardware. The entity may be a device for wireless communication, e.g. configured to communicate using RF waves. The entity may be a user equipment (UE). The entity may be a receiver UE (Rx UE). An UE may be a mobile phone, a handheld device, a device on a vehicle or a device on a robot, or the like. Wireless communication may comprise or may be communication using radio frequency (RF) waves. The entity may be an entity, such as a device, configured for sidelink communication.

In an implementation form of the second aspect, the entity is configured to receive with a beam on one or more resources of the multiple resources a reference signal and control information, and determine, based on the received control information, whether the reference signal is intended for itself.

In other words, the entity may be configured to determine, based on the received control information, whether it is a target entity for transmission of the received reference signal.

In an implementation form of the second aspect, the entity is configured to measure the reference signal received power (RSRP) of the reference signal received with the beam on the one or more resources of the multiple resources.

The entity may be configured to determine whether the measured RSRP is greater than or equal to a threshold value, and transmit a beam alignment response with the beam in case the measured RSRP is greater than or equal to the threshold value.

In an implementation form of the second aspect, the entity is configured to obtain, from the received control information, information on a sub-set of one or more resources of the multiple resources for transmitting a beam alignment response with the beam.

That is, the control information comprise an indication of the one or more resources of the multiple resources on which a beam alignment response is to be transmitted. The control information may comprise a mapping between two resources, one resource where the entity may receive a reference signal and a second resource where it may transmit a beam alignment response with regard to receiving the reference signal. The aforementioned sub-set of one or more resources may be the second sub-set or the fourth sub-set described with regard to implementation forms of the first aspect.

In an implementation form of the second aspect, the entity is configured to transmit, on the sub-set of one or more resources for transmitting the beam alignment response, the beam alignment response with the beam.

The entity may transmit the beam alignment response by transmitting a reference signal and control information.

In an implementation form of the second aspect, the entity is configured to obtain information on the multiple resources from a further entity for wireless communication, and/or a data storage associated to the entity.

In other words, the entity may be configured to obtain the configuration of the multiple resources from the further entity and/or the data storage associated to the entity. The entity may be configured to wirelessly receive the multiple resources from the further entity. The further entity may be a UE. The further entity may be a network device. A network device may be a next generation node B (gNB), a base station (BS), road side unit (RSU), a transmit/receive point (TRP) or the like. The data storage may be an internal data storage of the entity or an external data storage accessible by the entity.

The above description of the entity according to the first aspect is correspondingly valid for the entity according to the second aspect. The description of the entity according to the second aspect is correspondingly valid for the entity according to the first aspect.

The entity of the second aspect and its implementation forms and optional features achieve the same advantages as the entity of the first aspect and its respective implementation forms and respective optional features.

In order to achieve the entity according to the second aspect of this disclosure, some or all of the implementation forms and optional features of the second aspect, as described above, may be combined with each other.

A third aspect of this disclosure provides an entity for wireless communication, wherein the entity is configured to configure, for beam management by one or more further entities for wireless communication in a sidelink, multiple resources.

The entity may configured to configure, for beam management for a sidelink by one or more further entities for wireless communication in a sidelink, multiple resources. The entity may be configured to configure, for beam management by one or more further entities for wireless communication in a sidelink, the multiple resources that are part of a resource pool for sidelink communication. In other words, the entity may be configured to configure, for beam management by one or more further entities for wireless communication in a sidelink, the multiple resources among resources of a resource pool for sidelink communication. In the time domain, the resource pool may comprise contiguous or non-contiguous slots, where each slot comprises multiple symbols. In the frequency domain, the resource pool may be divided into multiple contiguous sub-channels. The resource pool may comprise a group of resources that are configured for data transmission, e.g. transmitting a data payload, i.e. a data packet.

The entity may be a network device. A network device may be a next generation node B (gNB), a base station (BS), road side unit (RSU), a transmit/receive point (TRP) or the like. The one or more further entities may each be a device for wireless communication, e.g. configured to communicate using RF waves. The one or more further entities may each be a user equipment (UE). An UE may be a mobile phone, a handheld device, a device on a vehicle or a device on a robot, or the like.

The above description of the entity according to the first aspect and the entity according to the second aspect is correspondingly valid for the entity according to the third aspect. The description of the entity according to the third aspect is correspondingly valid for the entity according to the first aspect and the entity according to the second aspect.

The entity of the third aspect and its implementation forms and optional features achieve the same advantages as the entity of the first aspect and its respective implementation forms and respective optional features.

In order to achieve the entity according to the third aspect of this disclosure, some or all of the implementation forms and optional features of the third aspect, as described above, may be combined with each other.

A fourth aspect of this disclosure provides a method for wireless communication in a sidelink. The method comprises for beam management in sidelink using, by an entity for wireless communication in a sidelink, a set of resources from multiple resources, wherein the multiple resources are configured for beam management.

The above description of the entity according to the first aspect is correspondingly valid for the method according to the fourth aspect.

In an implementation form of the fourth aspect, the method comprises performing, by the entity, beam management for a sidelink by transmitting and receiving one or more signals with one or more beams on the set of resources.

In an implementation form of the fourth aspect, the method comprises using by the entity, for beam management, the set of resources from the multiple resources, wherein the multiple resources are configured for beam management and are part of a resource pool for sidelink communication.

In an implementation form of the fourth aspect, the method comprises communicating by the entity according to a communication protocol, and the multiple resources are configured, according to the communication protocol, for beam management.

In an implementation form of the fourth aspect, the method comprises obtaining, by the entity, information on the set of resources from another entity for wireless communication, or selecting, by the entity, the set of resources from the multiple resources.

In an implementation form of the fourth aspect, the method comprises selecting, by the entity, the set of resources from the multiple resources by
searching, in the multiple resources, for control information using a beam of the entity,
determining based on the control information of one or more resources of the multiple resource, for which the control information is found using the beam, one or more reserved resources of the multiple resources,
determining among the multiple resources free resources by excluding the determined one or more reserved resources from the multiple resources, and
selecting at least one of the determined free resources as one or more resources of the set of resources.

In an implementation form of the fourth aspect, the method comprises selecting by the entity, for the beam, one or more of the determined free resources as one or more resources for transmitting a reference signal with the beam.

In an implementation form of the fourth aspect, the method comprises selecting by the entity, from the set of resources, a sub-set of one or more resources for transmitting with a beam of the entity a reference signal on the sub-set of one or more resources.

In an implementation form of the fourth aspect, the method comprises transmitting, by the entity, with the beam the reference signal and control information associated with the beam on the sub-set of one or more resources.

In an implementation form of the fourth aspect, the method comprises selecting by the entity, from the set of resources, a sub-set of one or more resources for receiving a beam alignment response with regard to a beam of the entity.

In an implementation form of the fourth aspect, the method comprises receiving by the entity the beam alignment response with regard to the beam of the entity on the sub-set of one or more resources for receiving the beam alignment response with regard to the beam of the entity.

In an implementation form of the fourth aspect, the method comprises selecting by the entity, from the set of resources, a sub-set of resources for transmitting with multiple beams of the entity a reference signal on the sub-set of resources.

In an implementation form of the fourth aspect, the method comprises transmitting, by the entity, with a beam of the multiple beams of the entity the reference signal and control information associated with the beam on one or more resources of the sub-set of resources.

In an implementation form of the fourth aspect, the method comprises selecting by the entity, for the beam, the one or more resources from the sub-set of resources.

In an implementation form of the fourth aspect, the method comprises selecting by the entity, from the set of resources, a sub-set of resources for receiving a beam alignment response with regard to multiple beams of the entity.

In an implementation form of the fourth aspect, the method comprises selecting by the entity, for a beam of the multiple beams, one or more resources for receiving the beam alignment response with regard to the beam of the multiple beams from the sub-set of resources for receiving the beam alignment response with regard to the multiple beams of the entity.

In an implementation form of the fourth aspect, the method comprises receiving, by the entity, the beam alignment response with regard to the beam of the multiple beams on the selected one or more resources.

In an implementation form of the fourth aspect, the method comprises searching, by the entity, for control information in the multiple resources.

In an implementation form of the fourth aspect, the method comprises obtaining, by the entity, information on the multiple resources from a further entity for wireless communication, and/or a data storage associated to the entity.

The method of the fourth aspect and its implementation forms and optional features achieve the same advantages as the entity of the first aspect and its respective implementation forms and respective optional features.

In order to achieve the method according to the fourth aspect of this disclosure, some or all of the implementation forms and optional features of the fourth aspect, as described above, may be combined with each other.

A fifth aspect of this disclosure provides a method for wireless communication in a sidelink, wherein the method comprises searching for control information in multiple resources that are configured for beam management.

The above description of the entity according to the second aspect is correspondingly valid for the method according to the fifth aspect.

In an implementation form of the fifth aspect, the method comprises receiving, by an entity for wireless communication in a sidelink, with a beam on one or more resources of the multiple resources a reference signal and control information, and determining by the entity, based on the received control information, whether the reference signal is intended for itself.

In an implementation form of the fifth aspect, the method comprises measuring, by an entity for wireless communication in a sidelink, the reference signal received power (RSRP) of the reference signal received with the beam on the one or more resources of the multiple resources.

In an implementation form of the fifth aspect, the method comprises obtaining by an entity for wireless communication in a sidelink, from the received control information, information on a sub-set of one or more resources of the multiple resources for transmitting a beam alignment response with the beam.

In an implementation form of the fifth aspect, the method comprises transmitting by an entity for wireless communication in a sidelink, on the sub-set of one or more resources for transmitting the beam alignment response, the beam alignment response with the beam.

In an implementation form of the fifth aspect, the method comprises obtaining, by an entity for wireless communication in a sidelink, information on the multiple resources from a further entity for wireless communication, and/or a data storage associated to the entity.

The method of the fifth aspect and its implementation forms and optional features achieve the same advantages as the entity of the first aspect and its respective implementation forms and respective optional features.

In order to achieve the method according to the fifth aspect of this disclosure, some or all of the implementation forms and optional features of the fifth aspect, as described above, may be combined with each other.

A sixth aspect of this disclosure provides a method for wireless communication, wherein the method comprises configuring, for beam management by one or more further entities for wireless communication in a sidelink, multiple resources. The method may comprise configuring the multiple resources for sidelink beam management by one or more further entities for wireless communication in a sidelink.

The above description of the entity according to the third aspect is correspondingly valid for the method according to the sixth aspect.

The method of the sixth aspect and its implementation forms and optional features achieve the same advantages as the entity of the first aspect and its respective implementation forms and respective optional features.

In order to achieve the method according to the sixth aspect of this disclosure, some or all of the implementation forms and optional features of the sixth aspect, as described above, may be combined with each other.

It has to be noted that all devices, elements, units and means described in the present application could be implemented in software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows an example of an entity for wireless communication according to this disclosure;

FIG. 2 shows an example of an entity for wireless communication according to this disclosure;

FIG. 3 shows an example of an entity for wireless communication according to this disclosure;

FIG. 4 shows an example of a use case of an example of the entity according to FIG. 1;

FIG. 5 shows an example of a use case of an example of the entity according to FIG. 1 and an example of the entity according to FIG. 2;

FIGS. 6a, 6b and 6c each show an example of a method for wireless communication according to this disclosure;

FIGS. 7, 8, 9 and 10 each show an example of a method for wireless communication according to this disclosure;

FIG. 11a shows an example of a transmitter user equipment transmitting with a beam and a receiver user equipment receiving with a beam; and

FIG. 11b shows an example of a transmitter user equipment transmitting with a beam and a user equipment sensing with a beam.

In the Figures corresponding elements are labelled by the same reference sign.

### DETAILED DESCRIPTION OF EMBODIMENTS

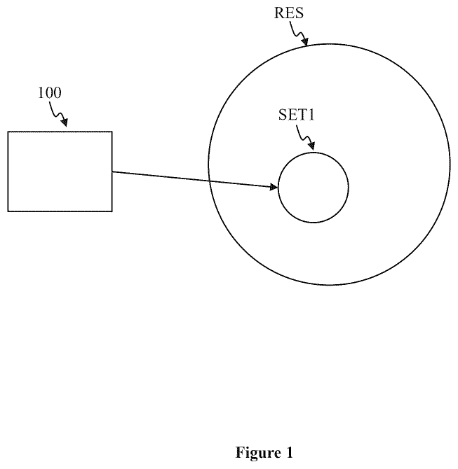

FIG. 1 shows an example of an entity for wireless communication according to this disclosure. The entity 100 of FIG. 1 is an example of the entity for wireless communication according to the first aspect of this disclosure. The description of the entity according to the first aspect is correspondingly valid for the entity 100 of FIG. 1.

The entity 100 of FIG. 1 is an entity for wireless communication in a sidelink. The entity 100 is configured to use, for beam management, a set of resources SET1 from multiple resources RES, wherein the multiple resources RES are configured for beam management.

The entity 100 may comprise a processor or processing circuitry (not shown) configured to perform, conduct or initiate the various operations of the entity 100 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable gate arrays (FPGAs), digital signal processors (DSPs), or multi-purpose processors. The entity 100 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the entity 100 to be performed. In one embodiment, the processing circuitry comprises one or more processors and a non-transitory memory connected to the one or more processors. The non-transitory memory may carry executable program code which, when executed by the one or more processors, causes the entity 100 to perform, conduct or initiate the operations or methods described herein.

The entity 100 may comprise one or more antennas for wireless communication. In case the entity 100 comprises multiple antennas, two or more of the multiple antennas may form an antenna array.

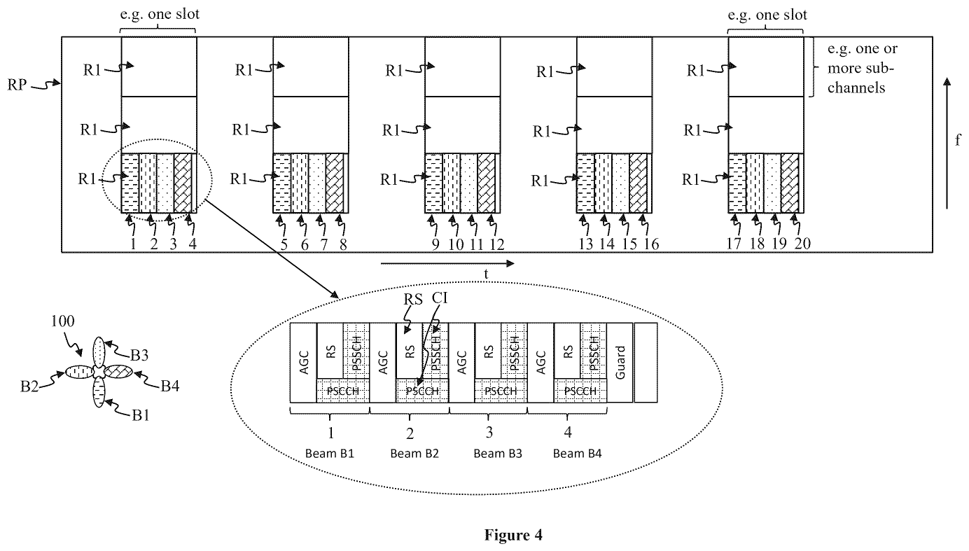

For further details on the entity 100 of FIG. 1 reference is made to the entity according to the first aspect of this disclosure and the description of FIGS. 4, 5, 7 and 8.

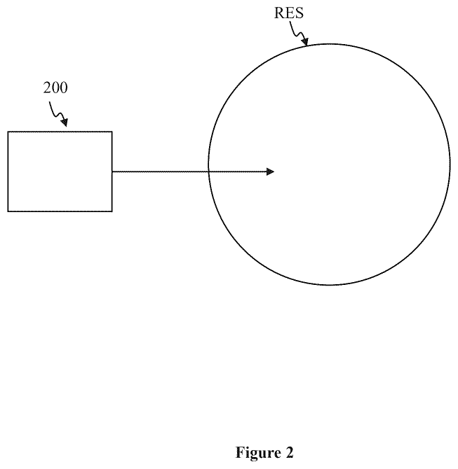

FIG. 2 shows an example of an entity for wireless communication according to this disclosure. The entity 200 of FIG. 2 is an example of the entity for wireless communication according to the second aspect of this disclosure. The description of the entity according to the second aspect is correspondingly valid for the entity 200 of FIG. 2.

The entity 200 of FIG. 2 is an entity for wireless communication in a sidelink, wherein the entity 200 is configured to search for control information in multiple resources RES that are configured for beam management.

The entity 200 may comprise a processor or processing circuitry (not shown) configured to perform, conduct or initiate the various operations of the entity 200 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable gate arrays (FPGAs), digital signal processors (DSPs), or multi-purpose processors. The entity 200 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the entity 200 to be performed. In one embodiment, the processing circuitry comprises one or more processors and a non-transitory memory connected to the one or more processors. The non-transitory memory may carry executable program code which, when executed by the one or more processors, causes the entity 200 to perform, conduct or initiate the operations or methods described herein.

The entity 200 may comprise one or more antennas for wireless communication. In case the entity 200 comprises multiple antennas, two or more of the multiple antennas may form an antenna array.

For further details on the entity 200 of FIG. 2 reference is made to the entity according to the second aspect of this disclosure and the description of FIGS. 4, 5, 9 and 10.

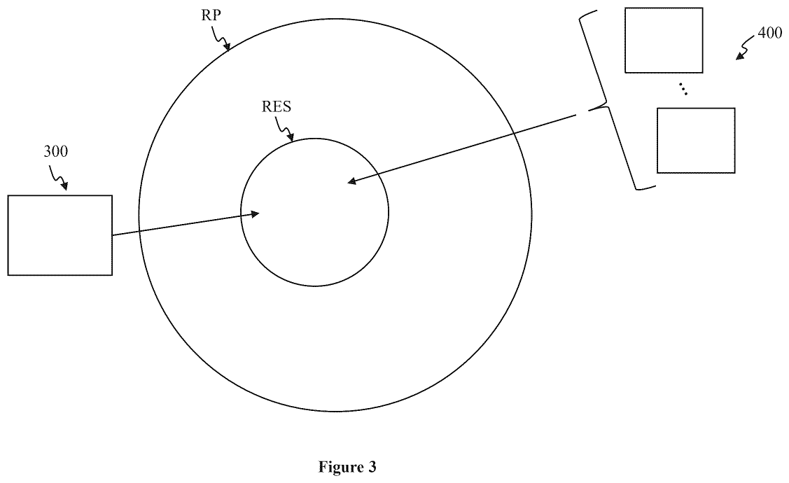

FIG. 3 shows an example of an entity for wireless communication according to this disclosure. The entity 300 of FIG. 3 is an example of the entity for wireless communication according to the third aspect of this disclosure. The description of the entity according to the third aspect is correspondingly valid for the entity 300 of FIG. 3.

The entity 300 of FIG. 3 is an entity for wireless communication, wherein the entity 300 is configured to configure, for beam management by one or more further entities 400 for wireless communication in a sidelink, multiple resources RES. The beam management may be a sidelink beam management. As shown in FIG. 3, the entity may be configured to configure, for beam management by the one or more further entities 400 for wireless communication in a sidelink, the multiple resources RES that may be part of a resource pool RP for sidelink communication.

The entity 300 may comprise a processor or processing circuitry (not shown) configured to perform, conduct or initiate the various operations of the entity 300 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable gate arrays (FPGAs), digital signal processors (DSPs), or multi-purpose processors. The entity 300 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the entity 300 to be performed. In one embodiment, the processing circuitry comprises one or more processors and a non-transitory memory connected to the one or more processors. The non-transitory memory may carry executable program code which, when executed by the one or more processors, causes the entity 300 to perform, conduct or initiate the operations or methods described herein.

The entity 300 may comprise one or more antennas for wireless communication. In case the entity 300 comprises multiple antennas, two or more of the multiple antennas may form an antenna array.

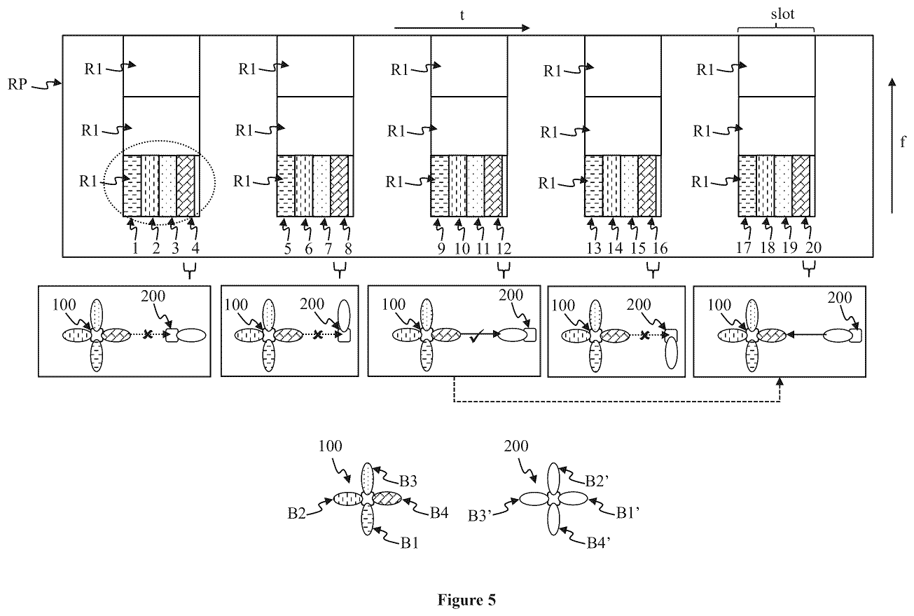

For further details on the entity 300 of FIG. 3 reference is made to the entity according to the third aspect of this disclosure and the description of FIGS. 4 and 5.

FIG. 4 shows an example of a use case of an example of the entity according to FIG. 1. For the use case of FIG. 4 it is assumed that the entity 100 is a transmitter user equipment (Tx UE) comprising four beams B1, B2, B3 and B4. The description of FIG. 4 is correspondingly valid in case the entity 100 is a different device for wireless communication and/or there is a different number of beams. Further, it assumed that the multiple resources RES, which are configured for beam management, are part of a resource pool RP for sidelink communication; in the time domain t, the resource pool RP comprises contiguous or non-contiguous slots, where each slot comprises multiple symbols; and in the frequency domain f, the resource pool RP is divided into multiple contiguous sub-channels. In FIG. 4, the multiple resources RES that are configured for beam management are indicated by the areas labelled with the reference signs “R1”. The rest of the resources of the resource pool RP may be used for other purposes, e.g. data transmission.

In the use case of FIG. 4, it is assumed that the Tx UE 100 uses a set of resources SET1 from the multiple resources RES, wherein the set of resources SET1 comprises twenty resources which are labelled by the reference signs 1 to 20. Further it is assumed, that the Tx UE 100 performs beam sweeping using its four beams B1, B2, B3 and B4 on sixteen resources, wherein it transmits a reference signal RS using a respective beam on four resources. For example, the Tx UE 100 transmits the reference signal RS with a first beam B1 on the resources 1, 5, 9 and 13. The Tx UE 100 transmits the reference signal RS with a second beam B2 on the resources 2, 6, 10 and 14. The Tx UE 100 transmits the reference signal RS with a third beam B3 on the resources 3, 7, 11 and 15. The Tx UE 100 transmits the reference signal RS with a fourth beam B4 on the resources 4, 8, 12 and 16. The reference signal RS may comprise or be at least one of a demodulation reference signal (DMRS), channel state information reference signal (CSI-RS), sidelink CSI-RS, sounding reference signal (SRS), synchronization signal block (SSB), sidelink SSB, primary synchronization signal (PSS), secondary synchronization signal (SSS), sidelink PSS, sidelink SSS, positioning reference signal (PRS), sidelink PRS, or the like. The description of FIG. 4 is correspondingly valid in case the Tx UE 100 uses a different number of beams and/or a different total number of resources for beam sweeping and/or a different number of resources per beam. It is assumed that the Tx UE 100 uses four resources for receiving for the transmissions with the four beams B1, B2, B3 and B4 a respective alignment response. For example, the resource 17 is assigned by the UE 100 for receiving an alignment response in case there is a beam alignment with the first beam B1. The resource 18 is assigned by the UE 100 for receiving an alignment response in case there is a beam alignment with the second beam B2. The resource 19 is assigned by the UE 100 for receiving an alignment response in case there is a beam alignment with the third beam B3. The resource 20 is assigned by the UE 100 for receiving an alignment response in case there is a beam alignment with the fourth beam B4. The description of FIG. 4 is correspondingly valid in case the UE 100 uses a different total number of resources for receiving an alignment response and/or a different number of resources per beam for receiving an alignment response.

In other words, the Tx UE 100 may be configured to select, from the set of resources SET1, a sub-set (first sub-set) of resources for transmitting with multiple beams of the Tx UE 100 a reference signal RS on the sub-set (first sub-set) of resources. The first sub-set of resources is assumed to comprise the resources 1 to 16, and the multiple beams are assumed to be the beams B1, B2, B3 and B4. As shown in FIG. 4, the Tx UE 100 is configured to transmit with a beam of the multiple beams of the Tx UE 100 the reference signal RS and control information CI associated with the beam on one or more resources of the first sub-set of resources. According to the example of FIG. 4, the UE 100 may transmit with each beam of the multiple beams B1, B2, B3 and B4 on four resources (resources 1, 5, 9 and 13 for beam B1, resources 2, 6, 10 and 14 for beam B2, resources 3, 7, 11 and 15 for beam B3, and resources 4, 8, 12 and 16 for beam B4) of the first sub-set of resources. For this, the UE 100 may select, for each beam, the respective resource(s) from the first sub-set of resources.

The Tx UE 100 may be configured to select, from the set of resources SET1, a sub-set (second sub-set) of resources for receiving a beam alignment response with regard to multiple beams of the Tx UE 100. The second sub-set of resources is assumed to comprise the resource 17 to 20, and the multiple beams are assumed to be the beams B1, B2, B3, and B4. The UE 100 may be configured to select, for a beam of the multiple beams of the UE 100, one or more resources for receiving the beam alignment response with regard to the beam of the multiple beams from the second sub-set of resources. According to the example of FIG. 4, the UE 100 may select, for each beam of the multiple beams B1, B2, B3 and B4, one resource (resource 17 for beam B1, resource 18 for beam B2, resource 19 for beam B3, and resource 20 for beam B4) for receiving the beam alignment response with regard to the beam from the second sub-set of resources. The UE 100 may be configured to receive the beam alignment response with regard to each beam of the multiple beams B1, B2, B3 and B4 on the respective selected one resource.

A resource within the multiple resources RES may comprise one or more symbols in one or more sub-channels. A resource within the set of resources SET1 may comprise one or more symbols in one or more sub-channels. Optionally, two or more resources of the set of resources SET1 may be different. A resource of the set of resources SET1 may be used for a beamformed transmission/reception, i.e. transmission/reception with a beam of the multiple beams B1, B2, B3 and B4 of the UE 100, of a reference signal RS and control information CI associated with the beam. For example, according to FIG. 4, the resources 1 to 16 are used for transmitting with a respective beam B1, B2, B3 or B4 of the UE 100 the reference signal RS and control information CI associated with the respective beam. According to FIG. 4, the resources 17 to 20 may be used for receiving with a respective beam B1, B2, B3 or B4 of the UE an alignment response, wherein the alignment response may for example comprise the reference signal RS and the control information CI associated with the respective beam.

As shown in the circle at the bottom of FIG. 4, the control information CI may comprise a Physical Sidelink Control Channel (PSCCH) and a Physical Sidelink Shared Channel (PSSCH). The control information CI may be referred to as sidelink control information (SCI). The SCI associated with the beamformed transmission, i.e. associated with a beam used for the transmission, may be transmitted in two stages: the PSCCH may carry a 1^{st}-stage SCI and the PSSCH may carry a 2^{nd}-stage SCI. The PSSCH may also carry a MAC subheader. The smallest scheduling unit of a resource for beam management (e.g. beam sweeping) may be different than the smallest scheduling unit for data transmissions, i.e. a sub-channel in one slot. According to the example of FIG. 4, three groups R1 of resources of the multiple resources RES may be multiplexed in the frequency domain in a slot, wherein a group R1 may for example comprise four resources (e.g. resources 1 to 4, resource 5 to 8, resources 9 to 12, or resources 13 to 16), for example for beam sweeping, multiplexed in the time domain. This is only by way of example and may be differently. The description is correspondingly valid. The SCI may also be sent only in the PSCCH, such that the reference signal is sent with PSCCH in a standalone manner, i.e., without PSSCH.

According to the example of FIG. 4, a slot may comprise fourteen symbols. Each resource 1 to 20 of the set of resources SET1 may comprise two symbols comprising PSCCH, PSSCH (i.e. the control information CI) and a reference signal RS for the beam sweeping. This is only by way of example and may be differently. The description is correspondingly valid. As exemplarily shown in the circle at the bottom of FIG. 4, the PSCCH may occupy a pre-determined set of frequency resources (i.e. frequency sub-channels) spanning two symbols of a respective resource (e.g. resource 1, resource 2, resource 3 or resource 4). The two symbols may be referred to as second and third symbol. The PSSCH and the reference signal RS may be multiplexed in the frequency domain with the PSCCH in the two symbols of the respective resource. Optionally, a first symbol may be used for automatic gain control (AGC) purposes. This symbol may comprise a duplication of the symbol next to it, i.e. the second symbol. The AGC symbol may be considered part of the respective resource (as it is exemplarily assumed in FIG. 4), and hence, the respective resource may comprise three symbols considering the AGC symbol. This is only by way of example and may be differently. The description is correspondingly valid. The example in FIG. 4 depicts four resources of the set of resources SET1 in one slot. In another example, one slot may comprise only one resource of the set of resources SET1.

All symbols in a respective resource may be transmitted with the same transmit power. In addition, no guard symbol may be required between consecutive resources of the set of resources SET1, but the AGC symbol allows for changing the beam (Tx beam or Rx beam) or transmit power between consecutive resources. A guard symbol may be introduced between consecutive resources to support a UE to switch from transmitting on a resource and receiving on the next consecutive resource.

The 1^{st}-stage SCI may carry the destination ID and optionally the source ID. The 1^{st}-stage SCI may comprise information on a reservation of further resources for beam sweeping (e.g. the first sub-set of resources 1 to 16 for for transmitting with the beams B1, B2, B3 and B4 the reference signal RS) and/or alignment response. This has the advantage that a receiver UE (Rx UEs), not shown in FIG. 4, may only decode the 1^{st}-stage SCI to determine if they are a target Rx UE for the beam sweeping procedure. In addition, this also allows for sensing UEs, not shown in FIG. 4, to decode only the 1^{st}-stage SCI to be aware of reserved resources, i.e. for supporting sensing in mode 2 resource allocation for selecting resources for a beam sweeping procedure. In case part of the source ID and destination ID is indicated in a MAC subheader carried by the PSSCH, an Rx UE decodes as well the PSSCH to verify if it is a target Rx UE for a beam sweeping procedure.

The 2^{nd}-stage SCI carries the source ID, if it is not carried in the 1^{st}-stage SCI, and/or an indication of the resources to be used for the alignment response (e.g. the second sub-set of resources 17 to 20 for receiving the beam alignment response with regard to the beams B1, B2, B3 and B4) along with the mapping to a beam sweeping resource. This has the advantage that only target Rx UEs decode 2^{nd}-stage SCI, e.g. to be aware on which resource(s) to transmit the alignment response. In addition, this has the advantage that the Tx UE 100 may configure the resources of the set of resources SET1 for beam sweeping and for the alignment response in a flexible manner. As shown in FIG. 4, multiple resources within the set of resources SET1 (e.g. in one slot or in multiple slots) may be reserved by the Tx UE 100 for a beam sweeping procedure, including resources for sweeping one or more Tx beams (e.g. the resources 1 to 16 for sweeping the beams B1 to B4) as well as resources for the beam alignment response associated with the one or more Tx beams (e. g the resources 17 to 20, wherein the resource 17 is associated with the beam B1, the resource 18 is associated with the beam B2, the resource 19 is associated with the beam B3, and the resource 20 is associated with the beam B4). As exemplarily shown in FIG. 4, the beam sweeping of a Tx beam may be performed in multiple resources over several slots, in order to support beam sweeping of different Rx beams at the Rx UE (shown in FIG. 5). According to the example of FIG. 4, the UE 100 employs four resources in a slot for the beam training of the four Tx beams B1 to B4. In addition, as shown in FIG. 4, the UE 100 may train each of the four Tx beams B1 to B4 over multiple slots within the set of resources SET1 of the multiple resources RES configured for beam management. The number of resources and/or beams used for beam sweeping according to FIG. 4 is only by way of example and may be different. The description is correspondingly valid.

The Tx UE 100 may select the set of resources SET1, e.g. for performing a beam sweeping procedure, following mode 1 or mode 2 resource allocation schemes. The Tx UE 100 may decide on its own which Tx beams (e.g. which of the beams B1, B2, B3 and B4) to employ for the beam sweeping, as well as which one or more resources of the set of resources SET1 to use for transmitting a reference signal RS with a given Tx beam. For example, according to FIG. 4, it is assumed that the UE 100 has decided to use all four beams B1 to B4, to use the resources 1, 5, 9 and 13 for transmitting the reference signal RS with the beam B1, to use the resources 2, 6, 10 and 14 for transmitting the reference signal RS with the beam B2, to use the resources 3, 7, 11 and 15 for transmitting the reference signal RS with the beam B3, and to use the resources 4, 8, 12 and 16 for transmitting the reference signal RS with the beam B4.

The Tx UE 100 may configure the resources for the alignment response, i.e. it may decide on its own which resource(s) to select for the alignment response, i.e. on which resource(s) it shall listen (i.e. receive) for an alignment response. For example, according to FIG. 4, it is assumed that the UE has decided to select the resource 17 to listen (i.e. receive) for an alignment response with regard to the beam sweeping using the beam B1, to select the resource 18 to listen (i.e. receive) for an alignment response with regard to the beam sweeping using the beam B2, to select the resource 19 to listen (i.e. receive) for an alignment response with regard to the beam sweeping using the beam B3, and to select the resource 20 to listen (i.e. receive) for an alignment response with regard to the beam sweeping using the beam B4. For example, the Tx UE 100 may perform beam sweeping with multiple Tx beams over multiple slots before configuring a slot for an alignment response associated with each of the sweeped Tx beams. In other words, the Tx UE 100 may train multiple Tx beams over multiple slots before configuring a slot for an alignment response associated with each of the trained Tx beams.

The slot structure for the slots with beam sweeping and for the alignment response may be the same. A Rx UE, which is the target Rx UE of a beam sweeping procedure, may transmit an alignment response on sub-set of resources selected by the Tx UE 100 from the set of resources SET1 for the alignment response. That is, the target Rx UE of a beam sweeping procedure may transmit an alignment response for a reference signal RS received with a given Tx beam. A Rx UE may decide to transmit an alignment response based on the RSRP, e.g. measured with a Rx beam of the Rx UE, associated with a reference signal RS transmitted by the Tx UE 100 with a given Tx beam. When sending the alignment response, the Rx UE may indicate reserved resources of the set of resources SET1 in the 1^{st}-stage SCI (for further beam management procedures, e.g. for beam maintenance between the Tx UE and Rx UE), based on the reserved resources of the set of resources SET1 indicated by the Tx UE in a 1^{st}-stage SCI received by the Rx UE. This allows a reservation of the same resources from the Tx UE 100 and Rx UE, i.e. from both sides of the link. The Rx UE may transmit the alignment response with the beam used to receive a Tx beam. With the beam alignment response, there is no need of a measurement report, as the Tx UE 100 may measure the quality of the channel when receiving the alignment response, and in this way, it may be aware of the best Tx beam based on the reply from the Rx UE. Optionally, a Rx UE may transmit a measurement report to the Tx UE 100, e.g., in a PSSCH. A Rx UE may transmit a measurement report in the alignment response, i.e. the RSRP associated with a reference signal RS transmitted with a given Tx beam. The aforementioned Rx UE is exemplarily shown in FIG. 5 as UE 200. It is an example of the entity according to the second aspect of the description and, thus, the description of the entity of the second aspect and description of the Rx UE 200 of FIG. 5 is correspondingly valid for the aforementioned Rx UE.

The Tx UE 100 does not need to use all the resources for beam sweeping in a slot of the set of resources SET1. For example, the Tx UE may transmit with Tx beam B1 and Tx beam B2 in the first two resources for beam sweeping in a slot. The half-duplex issue present in sidelink communication, i.e. that a UE may not be able to transmit and receive in a same symbol, may be addressed by configuring the Tx UE 100 to not transmit always on the set of resources SET1 for a beam sweeping procedure. This allows the Tx UE 100 to listen for beam sweeping related transmissions from other UEs. This is similar to how a SyncRef UE does not always transmit S-SSB to search for a synchronization source with higher priority in NR V2X in Rel. 16.

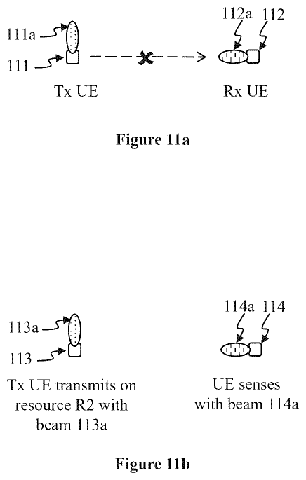

As the multiple resources RES that are configured for beam management are shared among multiple UEs, two UEs (e.g. UE A and UE B) may transmit a reference signal RS for beam sweeping on the same set of resources. For example, UE A (with beam X) and UE B (with beam Y) may transmit a transmission for beam sweeping on the same resource, e.g. in mode 2 if UE A (with beam X) and UE B (with beam Y) sensed the resource to be free. This is exemplarily shown, in FIG. 11b. In the example of FIG. 11b, it is assumed that the Tx UE 113 transmits with the beam 113a on the resource R2. Thus, when another UE 114 senses with the beam 114a, which is not aligned to the beam 113a, the UE 114 determines that the resource R2 is free for a transmission using the beam 114a. Therefore, the UE 113 may transmit with the beam 113a and the UE 114 may transmit with the beam 114a a transmission for beam sweeping on the same resource R2.

The Tx UE 100 of FIG. 4 may perform beam management, such as beam sweeping, before, during or after a link establishment with another UE. Before searching for a PSCCH in each sub-channel, for a potential data transmission intended for a Rx UE (not shown in FIG. 4), the Rx UE may first search for a beam management, e.g. beam sweeping, procedure intended for it within the multiple resources RES that are configured for beam management, as described below.

FIG. 5 shows an example of a use case of an example of the entity according to FIG. 1 and an example of the entity according to FIG. 2. The use case of FIG. 5 corresponds to the use case of FIG. 4, wherein FIG. 5 shows the Rx UE 200. Thus, the description of FIG. 4 is correspondingly valid for the use case of FIG. 5. For the use case of FIG. 5 it is assumed that the entity 100 is a transmitter user equipment (Tx UE) comprising four beams B1, B2, B3 and B4 and the entity 200 is a receiver user equipment (Rx UE) comprising four beams B1′, B2′, B3′ and B4′. The description of FIG. 5 is correspondingly valid in case the entity 100 and/or entity 200 is a different device for wireless communication and/or there is a different number of beams

As shown in FIG. 5, the Tx UE 100 may sweep its four Tx beams B1 to B4 on four resources (e.g. 1, 2, 3, 4 in a first slot) configured for beam sweeping in a slot. The Tx UE 100 may repeat the beam sweeping of the four Tx beams B1 to B4 over four different slots within the set of resources SET1. This allows the Rx UE 200 to receive with four Rx beams B1′ to B4′ a reference signal RS transmitted by the Tx UE 100 with each of the four Tx beams B1 to B4. That is, the Rx UE 200 may receive a transmission by the Tx UE 100 with each of the four Tx beams B1 to B4 using one Rx beam per slot (e.g. in the first slot comprising the resources 1 to 4 the Tx UE 100 may transmit using a different one of the four beams B1 to B4 at each resource and the Rx UE 200 may use the beam B1′ during the first slot for receiving transmissions on the resources 1 to 4). The number of slots, during which the beam sweeping is repeated, is only by way of example and may be different. The description is correspondingly valid. The reference signal RS may comprise or be at least one of a demodulation reference signal (DMRS), channel state information reference signal (CSI-RS), sidelink CSI-RS, sounding reference signal (SRS), synchronization signal block (SSB), sidelink SSB, primary synchronization signal (PSS), secondary synchronization signal (SSS), sidelink PSS, sidelink SSS, positioning reference signal (PRS), sidelink PRS, or the like.

The Tx UE 100 does not need to know the capability of the Rx UE 200, i.e. the number of Rx beams at the Rx UE 200, because the beam sweeping procedure may be repeated over several slots within the set of resources SET1, allowing multiple opportunities for the Rx UE 200 to receive with different Rx beams. In this way, the Rx UE 200 is able to measure the signal strength, i.e. RSRP, with different Tx beam-Rx beam pairs. For example, as shown in FIG. 5, in a first slot comprising the resources 1, 2, 3 and 4 the Rx UE 200 may receive with the Rx beam B1′. In a second slot comprising the resources 5, 6, 7 and 8 the Rx UE 200 may receive with the Rx beam B2′. In a third slot comprising the resources 9, 10, 11 and 12 the Rx UE 200 may receive with the Rx beam B3′. In a fourth slot comprising the resources 13, 14, 15 and 16 the Rx UE 200 may receive with the Rx beam B4′.

The Rx UE 200 is configured to identify the Rx beam B3′ as the best Rx beam and the Tx beam B4 of the Tx UE 100 used for a transmission on the resource 12 in the third slot as the best Tx beam. Although, the Rx UE 200 may have already identified a Rx beam with a sufficiently strong RSRP in the third slot of the set of resources SET1, the Tx UE 100 may still transmit reference signals RS in the fourth slot on the resources 13, 14, 15 and 16 of the set of resources SET1. Namely, the Tx UE 100 may not be aware of the aforementioned identification by the Rx UE 200 and the Rx UE 200 could still be able to identify a stronger Tx beam-Rx beam pair.

The Rx UE 200 may know on which resource it may transmit the alignment response associated with the identified best Tx beam (i.e. Tx beam B4), based on the control information (e.g. SCI) received with the best Tx beam-Rx beam pair, i.e. based on the control information received with the Rx beam B3′ on the resource 12 in the third slot of the set of resources SET1. The control information indicates the mapping (configured by the Tx UE 100) between a resource used for the transmission of a reference signal RS with a Tx beam (such as the resource 12 used in the third slot for transmission with the beam B4) and the resource that shall be used for the alignment response associated with that Tx beam (such as the resource 20 to be used for the alignment response associated with the Tx beam B4). This mapping may be indicated with the control information transmitted with each Tx beam in a resource. According to the example of FIG. 5, the Rx UE 200 may transmit an alignment response associated with the beam B4 on the resource 20 in a fifth slot of the configured set of resources SET1. For this, the Rx UE 200 may use the Rx beam B3′. That is, for indicating to the Tx UE the best Tx beam, the Rx UE 200 may transmit with the Rx beam B3′ an alignment response associated with the Tx beam B4 on the resource 20 in the fifth slot of the configured set of resources SET1. Thus, there may be a mapping between the resources 4, 8, 12 and 16, on which a reference signal is transmitted, e.g. beam sweeping is done, by the Tx UE 100 using the beam B4, and the resource 20, on which an alignment response with regard to the beam B4 shall be transmitted by the Rx UE 200 to the Tx UE 100.

The Tx UE 100 may listen for an alignment response on a resource with the beam used to transmit an associated reference signal RS. For example, the Tx UE 100 may receive with the Tx beam B4 the alignment response that is transmitted by the Rx UE 200 with the Rx beam B3′. After receiving the alignment response, the Tx UE 100 may be aware of the best Tx beam (which is the beam B4 according to the example of FIG. 5). The Tx UE 100 may measure the RSRP of the alignment response, which allows the Tx UE 100 to know the strength of the link.

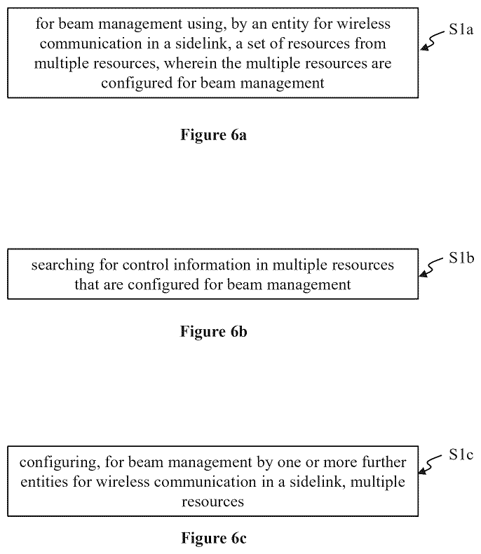

FIG. 6a shows an example of a method for wireless communication according to this disclosure. The method of FIG. 6a is an example of the method for wireless communication according to the fourth aspect of this disclosure. The description of the method according to the fourth aspect is correspondingly valid for the method of FIG. 6a.

The method of FIG. 6a is a method for wireless communication in a sidelink. The method comprises a step S1a of using, by an entity for wireless communication in a sidelink, for beam management a set of resources from multiple resources, wherein the multiple resources are configured for beam management. The entity may be for example the entity of FIG. 1. The entity of FIG. 1 may perform the method of FIG. 6a.

For further details on the method of FIG. 6a reference is made to the method according to the fourth aspect.

FIG. 6b shows an example of a method for wireless communication according to this disclosure. The method of FIG. 6b is an example of the method for wireless communication according to the fifth aspect of this disclosure. The description of the method according to the fifth aspect is correspondingly valid for the method of FIG. 6b.

The method of FIG. 6b is a method for wireless communication in a sidelink, wherein the method comprises a step S1b of searching for control information in multiple resources that are configured for beam management in sidelink. The method of FIG. 6b may be performed by an entity for wireless communication in a sidelink, such as the entity of FIG. 2.

For further details on the method of FIG. 6b reference is made to the method according to the fifth aspect

FIG. 6c shows an example of a method for wireless communication according to this disclosure. The method of FIG. 6c is an example of the method for wireless communication according to the sixth aspect of this disclosure. The description of the method according to the sixth aspect is correspondingly valid for the method of FIG. 6c.

The method of FIG. 6c is a method for wireless communication, wherein the method comprises a step S1c of configuring, for beam management by one or more further entities for wireless communication in a sidelink, multiple resources. The method of FIG. 6c may be performed by an entity for wireless communication, such as the entity of FIG. 3.

For further details on the method of FIG. 3 reference is made to the method according to the sixth aspect

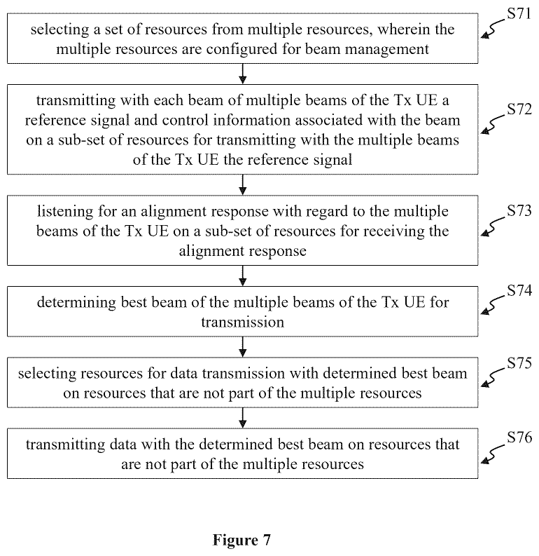

FIG. 7 shows an example of a method for wireless communication according to this disclosure. The method of FIG. 7 is an example of the method for wireless communication according to the fourth aspect of this disclosure. The description of the method according to the fourth aspect is correspondingly valid for the method of FIG. 7. The entity of FIG. 1 may perform the method of FIG. 7.

FIG. 7 shows an example for a procedure at a transmitter UE (Tx UE) that wants to transmit to a receiver UE (Rx UE) in a sidelink with a beamformed transmission. The Tx UE is assumed to be an example of the entity of FIG. 1. The Rx UE is assumed to be an example of the entity of FIG. 2. The following description is correspondingly valid in case the transmitter and/or receiver are a device different than a UE.

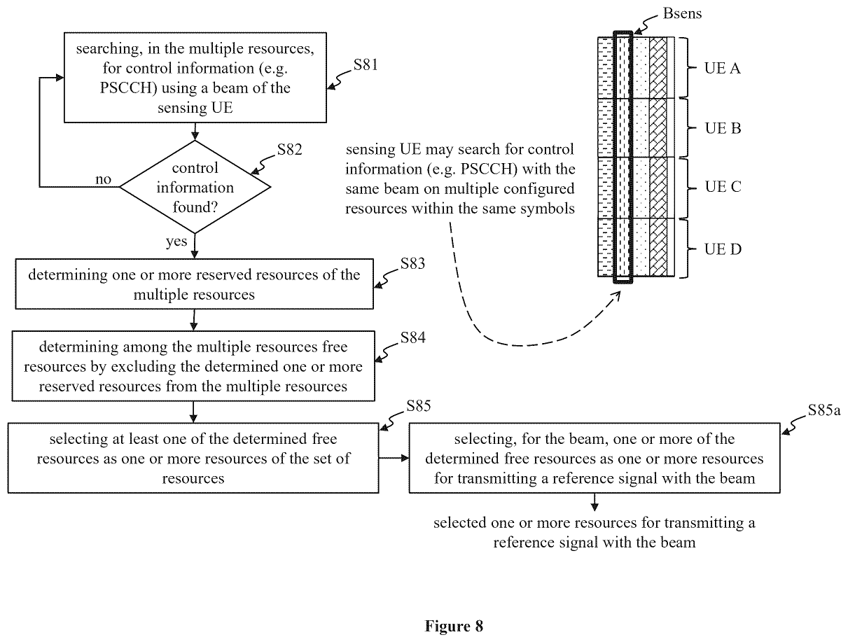

Based on a trigger to transmit data, the Tx UE may select a set of resources SET1 within multiple resources RES that are configured for beam management. The beam management may be sidelink beam management. It is assumed that the Tx UE wants to perform beam alignment and, thus, the set of resources SET1 may comprise resources for beam sweeping and for the beam alignment response. As the beam alignment may take place before a link is establishment between a pair of UEs, the selection of the set of resources SET1 for a beam management procedure, e.g. beam sweeping, may be performed without a trigger to transmit data as well. In other words, the method may comprise a step S71 of selecting a set of resources SET1 from multiple resources RES, wherein the multiple resources RES are configured for beam management. The resources RES may be configured for sidelink beam management. The step S71 may either be triggered by a trigger to transmit data or not. The step S71 may be performed on its own (i.e. independent of other steps) by the Tx UE. The selection of the set of resources SET1 may be done following mode 1 or mode 2 resource allocation schemes. In other words, the Tx UE may obtain information on the set of resources from another entity for wireless communication, which may be a network device. This corresponds to a selection that may be referred to as mode 1 resource allocation scheme. In this case, the network selects the set of resources SET1 from the multiple resources RES that are configured for beam management and indicates the selected set of resources SET1 to the Tx UE, e.g. wirelessly transmits the information on the selected set of resources SET1 to the Tx UE. Alternatively, the Tx UE may select the set of resources SET1 from the multiple resources RES that are configured for beam management. This corresponds to a selection that may be referred to as mode 2 resource allocation scheme. An example of such a mode 2 resource allocation scheme procedure is exemplarily described with regard to FIG. 8.

In a step S72 following the step S71, the Tx UE may transmit with each beam of multiple beams of the Tx UE a reference signal and control information associated with the beam on a sub-set (first sub-set) of resources (of the set of resources SET1) for transmitting with the multiple beams of the Tx UE the reference signal. The Tx UE may select, from the set of resources SET1, the first sub-set of resources. The control information may be a two-stage SCI as outlined above. In other words, the Tx UE may select, from the set of resource SET1, the sub-set of resources and transmit a reference signal and a two-stage SCI with different beams on the sub-set of resources. For the description of the control information that may be transmitted reference is made to the corresponding description of FIG. 4. Optionally, the two-stage SCI may comprise PSSCH carrying a MAC subheader that comprises other parts of the source ID and destination ID. The reference signal may comprise or be at least one of a demodulation reference signal (DMRS), channel state information reference signal (CSI-RS), sidelink CSI-RS, sounding reference signal (SRS), synchronization signal block (SSB), sidelink SSB, primary synchronization signal (PSS), secondary synchronization signal (SSS), sidelink PSS, sidelink SSS, positioning reference signal (PRS), sidelink PRS, or the like.

In a step S73 following the step S72, the Tx UE may receive a beam alignment response with regard to any one of the multiple beams on a sub-set (second sub-set) of resources (of the set of resources SET1) for receiving a beam alignment response with regard to the multiple beams of the Tx UE. The Tx UE may select, from the set of resources SET1, the second sub-set of resources. In other words, after the transmission with different Tx beams, in step S73, the Tx UE may listen for an alignment response with regard to the multiple beams of the Tx UE on the second sub-set of resources, i.e. on resources configured by the Tx UE for this purpose. The mapping between a resource used for a transmission with a Tx beam and a resource for the corresponding alignment response, may be indicated in the control information carried by a Tx beam, i.e. control information associated with the Tx beam. The Tx UE may listen for an alignment response, associated with a transmission with a Tx beam, with this same beam.

If the Tx UE does not receive a response, it may continue transmitting reference signals with its Tx beams. This allows the Rx UE to be able to receive with different Rx beams and to support Rx UEs with different number of Rx beams. In case that the Tx UE receives an alignment response, the Tx UE is then aware of the best Tx beam for transmission to the Rx UE. That is, in a step S74 following the step S73, the Tx UE may determine, using the alignment response received from the Rx UE, the best beam of the multiple beams of the Tx UE for transmission to the Rx UE. The Tx UE may measure the RSRP based on a reference signal sent by the Rx UE on the resource with the alignment response. The Rx UE may transmit a measurement report as part of the alignment response, indicating the RSRP measured with the best Tx beam-Rx beam pair. The RSRP may be used by the Tx UE to determine the Tx power to be used with a given Tx beam. After identifying the best Tx beam, the Tx UE may transmit back a confirmation to the Rx UE of the beam alignment. For this purpose, further resources within the set of resources SET1 may be used. Such resources may be reserved and indicated in the control information (e.g. SCI) transmitted with different Tx beams swept in a first round of a beam sweeping performed by the Tx UE. The steps S71, S72, S73 and S74 may be performed on their own as a procedure of beam management. That is, for performing a beam alignment procedure an entity for wireless communication, such as the Tx UE, may perform the step S71 to S74.

In an optional step S75 following the step S74, the Tx UE may select resources for data transmission with the best Tx beam (determined in step S74) on resources that are not part of the multiple resources RES, the multiple resources RES being configured for beam management. Such selection of resources may follow the same mode 1 and mode 2 procedure for resource allocation of data transmissions. The multiple resources may be part of a resource pool for sidelink communication. The resources for data transmission may be selected among resources in the resource pool that are not the multiple resources RES configured for beam management. The Tx UE may select resources for the data transmission based on the best Tx beam, e.g. by performing mode 2 sensing with the selected Tx beam as a Rx beam. The Tx UE may indicate to the Rx UE the selected resources to be used for the data transmission with the selected beam pair, i.e. in a transmission with the best Tx beam in a resource from the set of resources SET1. In an optional step S76 following the step S74, the Tx UE may transmit the data intended for the Rx UE with the best Tx beam on the selected resources for the data transmission.

FIG. 8 shows an example of a method for wireless communication according to this disclosure. The method of FIG. 8 is an example of the method for wireless communication according to the fourth aspect of this disclosure. The description of the method according to the fourth aspect is correspondingly valid for the method of FIG. 8. The entity of FIG. 1 may perform the method of FIG. 8.

FIG. 8 shows a flowchart of a procedure for a sensing UE that wants to select the set of resources SET1 from the multiple resources RES that are configured for beam management (e.g. sidelink beam management). That is, FIG. 8 shows an example of a selection of the set of resources SET1 based on a mode 2 resource allocation. The sensing UE is assumed to be an example of the entity of FIG. 1. The following description is correspondingly valid in case the sensing UE is a device different than a UE.

In a step S81 the sensing UE searches, in the multiple resources RES, for control information (e.g. for. PSCCH) using a beam of the UE. The UE may search in all potential locations of a PSCCH in each resource of the multiple resources RES for beam management, e.g. beam sweeping. For example, the sensing UE may detect the presence of a PSCCH by measuring the RSRP based on a reference signal transmitted within the PSCCH, such as a demodulation reference signal (DMRS). The sensing UE may perform the search using different beams, such that a sensing result is associated with a given beam. As indicated in FIG. 8, the sensing UE may search for control information (e.g. PSCCH) with the same beam Bsens on multiple resources within the same symbols. Such multiple resources may be used by different UEs (e.g. UE A, UE B, UE C and UE D) for their beam management, e.g. beam sweeping, procedure. As shown in FIG. 8, for resources on the same symbols but multiplexed in the frequency domain, the sensing UE may use the same beam Bsens to search for control information (e.g. PSCCH) in these different resources. In a step S82 following step S81, it is determined whether control information is found or not. In case no control information is found, i.e. “no” at step S82, the sensing UE may continue searching, in the multiple resources, for the control information. In case control information (e.g. PSSCH) is found, i.e. “yes” at step S82, then in a step S83 the sensing UE may determine, based on the control information of one or more resources of the multiple resources RES, for which the control information is found using the beam, one or more reserved resources of the multiple resources RES. For example, assuming the control information is in a PSCCH, the sensing UE may decode the PSCCH and determine one or more reserved resources of the multiple resources RES using the 1^{st}-stage SCI carried in the PSCCH. In this way, the sensing UE may determine reserved resources with a given beam. In a step S84 following the step S83, the sensing UE may determine among the multiple resources RES free resources by excluding the determined one or more reserved resources from the multiple resources RES. In a step S85 following the step S84, the sensing UE may select at least one of the determined free resources as one or more resources of the set of resources SET1. In an optional step S85a following the step S85 or replacing the step S85, the sensing UE may select, for the beam (used for the search in step S81), one or more determined free resources as one or more resources for transmitting a reference signal with the beam, e.g. for performing beam management, such as beam sweeping, with the beam. That is, optionally, on the resources reserved by other UEs of the multiple resources RES, the sensing UEs may perform resource selection for its beam management, e.g. beam sweeping, with the given beam. That is, the sensing UE may select some available resources after excluding reserved resources. The exclusion of reserved resources may follow a similar procedure as a resource selection for data transmissions with mode 2, i.e. resources may be excluded based on an RSRP threshold.

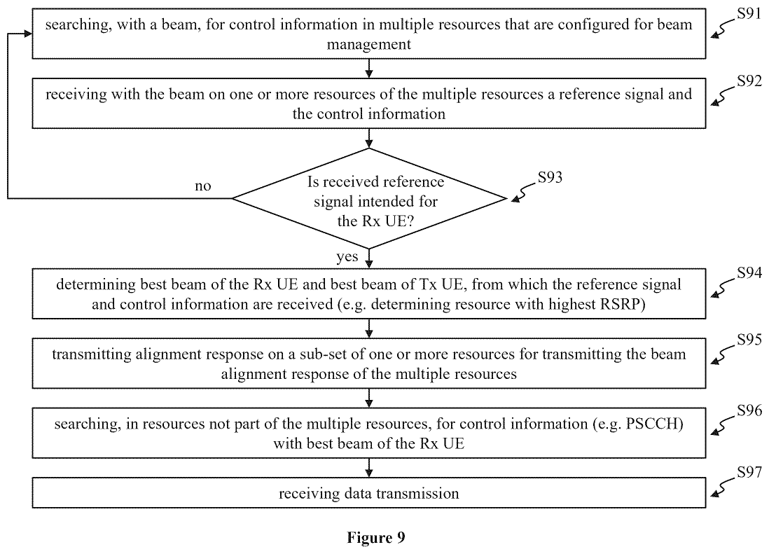

FIG. 9 shows an example of a method for wireless communication according to this disclosure. The method of FIG. 9 is an example of the method for wireless communication according to the fifth aspect of this disclosure. The description of the method according to the fifth aspect is correspondingly valid for the method of FIG. 9. The entity of FIG. 2 may perform the method of FIG. 9.

FIG. 9 shows an example of a procedure at a target receiver user equipment (target Rx UE) of a data transmission, i.e. at an Rx UE which is an intended Rx UE of a transmission. The target Rx UE is assumed to be an example of the entity of FIG. 2. The following description is correspondingly valid in case the target receiver is a device different than a UE.

In a step S91, the Rx UE searches, with a beam, for control information in multiple resources RES that are configured for beam management (e.g. sidelink beam management). That is, the Rx UE may search for a beam management, e.g. beam sweeping procedure, on multiple resources RES that are configured for beam management with a given Rx beam. For this purpose, the Rx UE may search for PSCCH at the potential location of PSCCH in each resource of the multiple resources RES. The UE may detect the presence of a PSCCH based on a reference signal sent within the PSCCH, such as a demodulation reference signal (DMRS). The UE may search for a beam management, e.g. beam sweeping procedure, based on the reference signal RS that may be transmitted in each resource of the multiple resources RES. That is, the UE may search for the PSCCH by measuring the RSRP associated with the reference signal that is transmitted in a resource for a beam alignment. If such an RSRP is above a threshold, the Rx UE may decode the PSCCH to determine whether the Rx UE is a target Rx UE of the beam sweeping procedure (e.g. using the source ID and destination ID carried in the 1^{st}-stage SCI). Optionally, a part of the UE ID may be contained in a MAC subheader that may carried by the PSSCH. In this case, the Rx UE may decode the PSSCH to determine whether it is a target Rx UE. Thus as outlined above, in a step S92 following the step S91, the Rx UE may receive with the beam on one or more resources of the multiple resources RES a reference signal RS and control information CI. The control information may be as outlined with regard to FIG. 4. In a step S93, it is determined whether the received reference signal is intended for the Rx UE. In case it is not intended for the Rx UE, i.e. “no” at step S93, the Rx UE may continue searching, with the beam, for control information in the multiple resources RES. In case the received reference signal is intended for the Rx UE, i.e. “yes” at step S93, the Rx UE may determine, in a step S94, the best beam of the Rx UE and best beam of a Tx UE, from which the reference signal and control information are received. That is, in case the Rx UE has identified a beam management, e.g. beam sweeping, procedure intended for it, it may determine in step S94 the best Rx beam. For this purpose, the Rx UE may measure the RSRP on the different resources of the beam management, e.g. beam sweeping, procedure. That is, the Rx UE may determine the best beam of the Rx UE and best beam of the Tx UE by determining a resource with highest RSRP.

The Rx UE may determine the resource(s) of the multiple resources RES on which it shall transmit an alignment response. This is done based on the mapping between a Tx beam and resources for the associated alignment response of the multiple resources RES. The Rx UE may obtain this information on the resource(s) for transmitting the alignment response, e.g. information on the aforementioned mapping, using the control information received with the best Tx beam in a resource, i.e. based on the control information received on the resource where the UE measured the best beam pair, i.e. determined the best beam of the Rx UE and best beam of the Tx UE.

In a step S95 following the step S94, the Rx UE may transmit the alignment response on the sub-set of one or more resources for transmitting the beam alignment response of the multiple resources RES. For example, the Rx UE may transmit the alignment response with the best beam used to receive the best Tx beam. As part of the alignment response, the Rx UE may transmit a PSCCH indicating reserved resources for the beam management, e.g. beam sweeping, procedure. The Rx UE may transmit a reference signal as part of the alignment response, i.e., to allow the Tx UE to measure the RSRP of the alignment response. As part of the alignment response, the Rx UE may transmit PSSCH, which may carry the 2^{nd}-stage SCI and another part of the source ID and destination ID. After transmitting the alignment response, the Rx UE may optionally listen in resources reserved for the beam management, e.g. beam sweeping, procedure of the Tx UE for a confirmation from the Tx UE, i.e. for an acknowledgment of reception of the beam alignment by the Tx UE. The steps S91, S92, S93, S94, and S95 may be performed on their own. They may be especially performed by an Rx UE in a beam alignment procedure for indicating that a best Tx beam-Rx beam pair is found by transmitting an alignment response from the Rx UE to the Tx UE.

In an optional step S96 following the step S95, the Rx UE searches, in resources that are not part of the multiple resources RES, for control information with the best beam of the Rx UE (that was determined in step S94). For example, the Rx UE may search for PSCCH with the best Rx beam, in resources for the data communication, i.e. in resources that are not part of the multiple resources RES, the multiple resources RES being configured for beam management. In an optional step S97 following the step S96, the Rx UE may receive a data transmission. For example, after the Rx UE detects a PSCCH of a data transmission and decodes the 2^{nd}-stage SCI to determine it is an intended Rx UE of the data transmission, the Rx UE may receive the data carried in the PSSCH associated with the detected PSCCH.

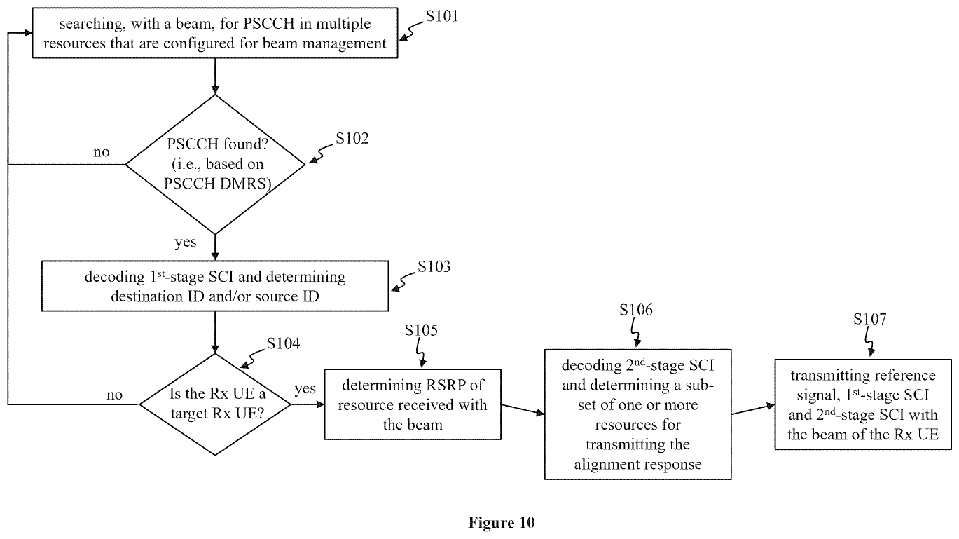

FIG. 10 shows an example of a method for wireless communication according to this disclosure. The method of FIG. 10 is an example of the method for wireless communication according to the fifth aspect of this disclosure. The description of the method according to the fifth aspect is correspondingly valid for the method of FIG. 10. The entity of FIG. 2 may perform the method of Figure10.

FIG. 10 shows an example of a procedure at a target receiver user equipment (target Rx UE) of a data transmission, i.e. at an Rx UE which is an intended Rx UE of a transmission. The target Rx UE is assumed to be an example of the entity of FIG. 2. The following description is correspondingly valid in case the target receiver is a device different than a UE.

In the Step S101, the Rx UE searches, with a given Rx beam, for a PSCCH on the multiple resources RES that are configured for beam management. In step S102 following the step S101, the Rx UE may detect the presence of a PSCCH based on the demodulation reference signal (DMRS) carried within the PSCCH. In case the Rx UE has not found a PSCCH, i.e. “no” at step S102, the Rx UE may continue searching for PSCCH. In case the Rx UE has found a PSCCH, “yes” at step S102, the Rx UE decodes, in a step S103, the 1^{st}-stage SCI to determine the destination ID and/or source ID and to check, in a step S104, whether the Rx UE is a target Rx UE of the beam management, e.g. beam sweeping, procedure. A part of the source ID and destination ID may be carried in a MAC subheader that may be carried within the PSSCH. In this case, the Rx UE may decode the PSSCH for this purpose.

In case the Rx UE is not a target Rx UE, i.e. “no” at step S104, the Rx UE may continue searching for PSCCH. In case the Rx UE is a target Rx UE, i.e. “yes” at step S104, it may determine the RSRP of a resource received with the beam (used for the search in step S101). In other words, in case the Rx UE has identified a beam management, e.g. beam sweeping, procedure intended for it, the Rx UE may, in step S105, measure the RSRP of a resource received with the given Rx beam (used for the search in step S101). In a step S106 following the step S105, the Rx UE may decode the 2^{nd}-stage SCI to determine a sub-set of one or more resources for transmitting the alignment response associated with a Tx beam. In a step S107 following the step S106, the Rx UE may transmit, with the given Rx beam, the alignment response on the corresponding resources (i.e. on the sub-set of one or more resources) comprising a reference signal, a PSCCH carrying a 1^{st}-stage SCI and a PSSCH carrying a 2^{nd}-stage SCI. Optionally the alignment response may comprise a MAC subheader carrying further parts of the source ID and destination ID.

The above examples of use cases and methods described with regard to FIGS. 4 to 10 may be applied before, during and after the link establishment between a pair of UEs. In case it is done before the link establishment, the Tx UE may perform a beam management, e.g. beam sweeping, procedure intended for all Rx UEs, i.e. in a broadcast manner, assuming that the Tx UE and the Rx UEs are part of a common network. In this case, the destination ID corresponds to all Rx UEs. In case it is done during the link establishment, the Tx UE may transmit in the control information, e.g. in the PSSCH, a direct communication request (DCR) message for the link establishment. The Rx UE may then transmit a direct communication accept (DCA) message as part of the alignment response. To support multiple Rx UEs sending back an alignment response, different reference signals may be considered or used for different UEs. For example, the different reference signals for different UEs can be orthogonal. In case it is done after the link establishment, the Tx UE may perform the beam management, e.g. beam sweeping, procedure intended for a specific Rx UE, i.e. with a proper source ID and destination ID.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. An entity (100) for wireless communication in a sidelink, wherein
the entity (100) is configured to use, for beam management, a set of resources (SET1) from multiple resources (RES), wherein the multiple resources (RES) are configured for beam management.

2. The entity (100) according to claim 1, wherein
the entity (100) is configured to perform beam management for a sidelink by transmitting and receiving one or more signals with one or more beams (B1, B2, B3, B4) on the set of resources (SET1).

3. The entity (100) according to claim 2, wherein
the entity (100) is configured to use, for beam management, the set of resources (SET1) from the multiple resources (RES), wherein the multiple resources (RES) are configured for beam management and are part of a resource pool for sidelink communication.

4. The entity (100) according to of claim 3, wherein
the entity (100) is configured to communicate according to a communication protocol, and
the multiple resources (RES) are configured, according to the communication protocol, for beam management.

5. The entity (100) according to claim 4, wherein the entity (100) is configured to
obtain information on the set of resources (SET1) from another entity for wireless communication, or
select the set of resources (SET1) from the multiple resources (RES).

6. The entity (100) according to claim 5, wherein the entity (100) is configured to select the set of resources (SET1) from the multiple resources (RES) by
searching (S81), in the multiple resources (RES), for control information (CI) using a beam of the entity (100),
determining (S83) based on the control information (CI) of one or more resources of the multiple resource (RES), for which the control information (CI) is found using the beam, one or more reserved resources of the multiple resources (RES),
determining (S84) among the multiple resources (RES) free resources by excluding the determined one or more reserved resources from the multiple resources (RES), and
selecting (S85) at least one of the determined free resources as one or more resources of the set of resources (SET1).

7. The entity (100) according to claim 6, wherein
the entity (100) is configured to select (S85a), for the beam, one or more of the determined free resources as one or more resources for transmitting a reference signal (RS) with the beam.

8. The entity (100) according to claim 7, wherein
the entity (100) is configured to select, from the set of resources (SET1), a sub-set of one or more resources for transmitting with a beam of the entity (100) a reference signal (RS) on the sub-set of one or more resources.

9. The entity (100) according to claim 8, wherein
the entity (100) is configured to select, from the set of resources (SET1), a sub-set of one or more resources for receiving a beam alignment response with regard to a beam of the entity (100).

10. The entity (100) according to claim 7, wherein
the entity (100) is configured to select, from the set of resources (SET1; 1, 2, 3, 4, 5, 6, 7, 8, 9, 10, 11, 12, 13, 14, 15, 16, 17, 18, 19, 20), a sub-set of resources (1, 2, 3, 4, 5, 6, 7, 8, 9, 10, 11, 12, 13, 14, 15, 16) for transmitting with multiple beams (B1, B2, B3, B4) of the entity (100) a reference signal (RS) on the sub-set of resources (1, 2, 3, 4, 5, 6, 7, 8, 9, 10, 11, 12, 13, 14, 15, 16).

11. The entity (100) according to claim 10, wherein
the entity (100) is configured to search for control information (CI) in the multiple resources (RES).

12. An entity (200) for wireless communication in a sidelink, wherein
the entity (200) is configured to search for control information in multiple resources (RES) that are configured for beam management.

13. The entity (100, 200) according to claim 12, wherein the entity (100, 200) is configured to obtain information on the multiple resources (RES) from
a further entity for wireless communication, and/or
a data storage associated to the entity.

14. An entity (300) for wireless communication, wherein
the entity (300) is configured to configure, for beam management by one or more further entities (400) for wireless communication in a sidelink, multiple resources (RES).
